(19) United States
(12) Patent Application Publication
(10) Pub. No.: US 2005/0131694 A1
(43) Pub. Date: Jun. 16, 2005

(54) Acoustic model creating method, acoustic model creating apparatus, acoustic model creating program, and speech recognition apparatus

(75) Inventors: Masanobu Nishitani, Suwa-shi (JP); Yasunaga Miyazawa, Okaya-shi (JP); Hiroshi Matsumoto, Nagano-shi (JP); Kazumasa Yamamoto, Nagano-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/998,065

(22) Filed: Nov. 29, 2004

(30) Foreign Application Priority Data
Dec. 12, 2003 (JP) 2003-415440

(51) Int. Cl. G10L 15/14

(52) U.S. Cl. 704/256

(57) ABSTRACT

Exemplary embodiments of the invention enhance the recognition ability by optimizing the distribution numbers for respective states that constitute an HMM (for example, a syllable HMM). Exemplary embodiments provide a distribution number setting device to increment the distribution number step by step for each state in an HMM; an alignment data creating unit to create alignment data by matching each state having been set to a specific distribution number to training speech data; a description length calculating unit to find, according to the Minimum Description Length criterion, a description length of each state in an HMM having the present time distribution number and a description length of each state in an HMM having the immediately preceding distribution number, with the use of the alignment data; and an optimum distribution number determining device to set an optimum distribution number to each state on the basis of the size of the description length found for each state in the HMM having the present time distribution number and the description length found for each state in the HMM having the immediately preceding distribution number.

### BACKGROUND

Exemplary embodiments of the present invention relate to an acoustic model creating method, an acoustic model creating apparatus, and an acoustic model creating program to create Continuous Mixture Density HMM's (Hidden Markov Models) as acoustic models, and to a speech recognition apparatus using these acoustic models.

In the related art, recognition generally adopts a method by which phoneme HMM's or syllable HMM's are used as acoustic models, and a speech, in units of words, clauses, or sentences, is recognized by connecting these phoneme HMM's or syllable HMM's. Continuous Mixture Density HMM's, in particular, have been used extensively as acoustic models having higher recognition ability.

An HMM may include one to ten states and a state transition from one to another. When an appearance probability of a symbol (a speech feature vector at a given time) in each state is calculated, the recognition accuracy is higher as the Gaussian distribution number increases in Continuous Mixture Density HMM's. However, when the Gaussian distribution number increases, so does the number of parameters, which poses a problem that a volume of calculation and a quantity of used memories are increased. This problem is particularly serious when a speech recognition function is provided to an inexpensive device that needs to use a low-performance processor and a small-capacity memory.

Also, for related art Continuous Mixture Density HMM's, the Gaussian distribution number is the same for all the states in respective phoneme (or syllable) HMM's. Hence, over-training occurs for a phoneme (or syllable) HMM having a small quantity of training speech data, which poses a problem that the recognition ability of the corresponding phoneme (syllable) is deteriorated.

As has been described, the related art provides for Continuous Mixture Density HMM's that have the Gaussian distribution number constant for all the states in respective phonemes (or syllables).

Meanwhile, in order to enhance the recognition accuracy, the Gaussian distribution number for each state needs to be sufficiently large. However, as has been described, when the Gaussian distribution number increases, so does the number of parameters, which poses a problem that a volume of calculation and a quantity of used memories are increased. Hence, in the related art, the Gaussian distribution number cannot be increased indiscriminately.

Accordingly, it is proposed to optimize the Gaussian distribution number for each state in phoneme (or syllable) HMM's. By using a syllable HMM as an example, for instance, of all the states constituting a given syllable HMM, there are states in a unit that have a significant influence on recognition and states that have a negligible influence. By taking this into account, the Gaussian distribution number is increased for states in a unit that has a significant influence on recognition, whereas the Gaussian distribution number is reduced for states having a negligible influence on recognition.

A technique described in related art document 1 Koichi SHINODA and Kenichi ISO, “MDL kijyun o motiita HMM saizuno sakugen” Proceedings of the Acoustical Society of Japan, 2002 Spring Conference, March 2002, pp. 79-80 (hereinafter “Shinoda”) specified below is an example of a technique to optimize the Gaussian distribution number for each state in a phoneme (or syllable) HMM in this manner.

### SUMMARY

Shinoda describes the technique to reduce the Gaussian distribution numbers for respective states in a unit that contributes less to recognition. Simply speaking, an HMM trained with a sufficient quantity of training speech data and having a large distribution number is prepared, and a tree structure of the Gaussian distribution numbers for respective states is created. Then, a description length of each state is found according to the Minimum Description Length (MDL) criterion to select a set of the Gaussian distribution numbers with which the description lengths are minimums.

According to the related art, it is indeed possible to effectively reduce the Gaussian distribution number for each state in a phoneme (or syllable) HMM. Moreover, it is possible to optimize the Gaussian distribution number for each state. High recognition rate, therefore, is thought to be maintained while reducing the number of parameters by reducing the Gaussian distribution number.

The related art, however, makes a tree structure of the Gaussian distribution number for each state and selects a set (combinations of nodes) of Gaussian distributions with which description lengths according to the MDL criterion that are minimums among distributions of the tree structure. Hence, the number of combinations of nodes to obtain the optimum distribution number for a given state is extremely large, and many computations need to be performed to find a description length of each combination.

According to the MDL criterion, when a model set {1, . . . , i, . . . , I} and data χ^{N}={χ₁, . . . , χ_{N}} are given, the description length li(χ^{N}) using a model i is defined as Equation (1)

$${l}_{i} ( {x}^{N} ) = - log {P}_{\hat{θ} ( i )} ( {x}^{N} ) + \frac{{β}_{i}}{2} log N + log I \qquad ( 1 )$$

According to the MDL criterion, a model whose description length li(χ^{N}) is a minimum is assumed to be an optimum model. However, because an extremely large number of combinations of nodes are possible in the related art, when a set of optimum Gaussian distributions is selected, description lengths of a set of Gaussian distributions, including combinations of nodes, are found with the use of a description length equation approximated to Equation (1) above. When description lengths of a set of Gaussian distributions, including combinations of nodes, are found from an approximate expression in this manner, a problem on a small or large scale may occur in accuracy of the result thus found.

Exemplary embodiments of the invention therefore have an object to provide an acoustic model creating method, an acoustic model creating apparatus, and an acoustic model creating program capable of creating HMM's that can attain high recognition ability with a small volume of computation. Exemplary embodiments enable the Gaussian distribution number for each state in respective phoneme (or syllable) HMM's to be set to an optimum distribution number according to the MDL criterion, and provide a speech recognition apparatus that, by using acoustic models thus created, becomes applicable to an inexpensive system whose hardware resource, such as computing power and a memory capacity, is strictly limited.

(1) An acoustic model creating method of exemplary embodiments of the invention is an acoustic model creating method of optimizing Gaussian distribution numbers for respective states constituting an HMM (hidden Markov Model) for each state. Thereby exemplary embodiments create an HMM having optimized Gaussian distribution numbers, which is characterized by including: incrementing a Gaussian distribution number step by step according to a specific increment rule for each state in plural HMM's, and setting each state to a specific Gaussian distribution number; creating matching data by matching each state in respective HMM's, which has been set to the specific Gaussian distribution number in the distribution number setting, to training speech data; finding, according to a Minimum Description Length criterion, a description length of each state in respective HMM's having a Gaussian distribution number at a present time to be outputted as a present time description length. Exemplary embodiments further provide finding, according to the Minimum Description Length criterion, a description length of each state in respective HMM's having a Gaussian distribution number immediately preceding the present time to be outputted as an immediately preceding description length, with the use of the matching data created in the matching data creating; and comparing the present time description length with the immediately preceding description length in size, both of which are calculated in the description length calculating, and setting an optimum Gaussian distribution number for each state in respective HMM's on the basis of a comparison result.

It is thus possible to set the optimum distribution number for each state in respective HMM's, and the recognition ability can be thereby enhanced. In particular, a noticeable characteristic of HMM's of exemplary embodiments of the invention is that they are Left-to-Right HMM's of a simple structure, which can in turn simplify the recognition algorithm. Also, HMM's of exemplary embodiments of the invention, being HMM's of a simple structure, contribute to the lower prices and the lower power consumption, and general recognition software can be readily used. Hence, they can be applied to a wide range of recognition apparatus, and thereby attain excellent compatibility.

Also, in exemplary embodiments of the invention, the distribution number for each state in respective HMM's is incremented step by step according to the specific increment rule, and the present time description length and the immediately preceding description length are found, so that the optimal distribution number is determined on the basis of the comparison result. The processing to optimize the distribution number can be therefore more efficient.

(2) In the acoustic model creating method according to (1), according to the Minimum Description Length criterion, when a model set {1, . . . , i, . . . , I} and data χ^{N}={χ₁, . . . , χ_{N}} (where N is a data length) are given, a description length li(χ^{N}) using a model i is expressed by a general equation defined by Equation above. In the general equation to find the description length, let the model set {1, . . . , i, . . . , I} be a set of HMM's when the distribution number for each state in the HMM is set to plural kinds from a given value to a maximum distribution number. Then, given I kinds (I is an integer satisfying I≧2) as the number of the kinds of the distribution number, 1, . . . , i, . . . , I are codes to specify respective kinds from a first kind to an I'th kind, and Equation (1) above is used as an equation to find a description length of an HMM having the distribution number an i'th kind among 1, . . . , i, . . . , I.

Hence, when the distribution number is incremented step by step from a given value according to the specific increment rule for each state in a given HMM, the description lengths can be readily calculated for HMM's that have been set to have respective distribution numbers.

(3) In the acoustic model creating method according to (2), it is preferable to use Equation (2)

$${l}_{i} ( {x}^{N} ) = - log {P}_{\hat{θ} ( i )} ( {x}^{N} ) + α ( \frac{{β}_{i}}{2} log N ) \qquad ( 2 )$$

which is re-written from Equation (1) above, as an equation to find the description length.

Equation (2) above is an equation re-written from the general equation to find the description length defined as Equation (1) above, by multiplying the second term on the right side by a weighting coefficient α, and omitting the third term on the right side that stands for a constant. By omitting the third term on the right side that stands for a constant in this manner, the calculation to find the description length can be simpler.

(4) In the acoustic model creating method according to (3), α in Equation (2) above is a weighting coefficient to obtain an optimum distribution number.

By making the weighting coefficient α used to obtain the optimum distribution number variable, it is possible to make a slope of a monotonous increase in the second term variable (the slope is increased as α is made larger), which can in turn make the description length li(χ^{N}) variable. Hence, by setting a to be larger, for example, it is possible to adjust the description length li(χ^{N}) to be a minimum when the distribution number is smaller.

(5) In the acoustic model creating method according to any of (2) through (4), the data χ^{N} is a set of respective pieces of training speech data obtained by matching, for each state in time series, HMM's having an arbitrary distribution number among the given value through the maximum distribution number to many pieces of training speech data.

By calculating the description lengths using, as the data χ^{N} in Equation (1) above, the training speech data obtained by using respective HMM's having an arbitrary distribution number, and by matching each HMM to many pieces of training speech data corresponding to the HMM in time series, it is possible to calculate the description lengths with accuracy.

(6) In the acoustic model creating method according to any of (2) through (5), in the description length calculating, a total number of frames and a total likelihood are found for each state in respective HMM's with the use of the matching data, for respective HMM's having the present time Gaussian distribution number. The present time description length is found by substituting the total number of frames and the total likelihood in Equation (2) above, while a total number of frames and a total likelihood are found for each state in respective HMM's with the use of the matching data, for respective HMM's having the immediately preceding Gaussian distribution number. The immediately preceding description length is found by substituting the total number of frames and the total likelihood in Equation (2) above.

It is thus possible to find the description length of an HMM having the present time distribution number and the description length of an HMM having the immediately preceding distribution number, which in turn enables the judgment as to whether the distribution number is optimum, to be made adequately.

(7) In the acoustic model creating method according to any of (1) through (6), in the optimum distribution number determining, as a result of comparison of the present time description length with the immediately preceding description length, when the immediately preceding description length is smaller than the present time description length, the immediately preceding Gaussian distribution number is assumed to be an optimum distribution number for a state in question. When the present time description length is smaller than the immediately preceding description length, the present time Gaussian distribution number is assumed to be a tentative optimum distribution number at this point in time for the state in question.

When the immediately preceding description length is smaller than the present time description length, the Gaussian distribution number set immediately before is assumed to be the optimum distribution number for the state in question, and when the present time description length is smaller than the immediately preceding description length, the present time Gaussian distribution number is assumed to be a tentative optimum distribution number at this point in time for the state in question. The optimum distribution number can be thereby set efficiently for each state, which can in turn reduce a volume of computation needed to optimize the distribution number.

(8) In the acoustic model creating method according to (7), in the distribution number setting, for the state judged as having the optimum distribution number, the Gaussian distribution number is held at the optimum distribution number, and for the state judged as having the tentative optimum distribution number, the Gaussian distribution number is incremented according to the specific increment rule.

The distribution number incrementing processing is thus no longer performed for a state judged as having the optimum distribution number. Hence, the processing needed to optimize the distribution number can be made more efficient, and a volume of computation can be reduced.

(9) In the acoustic model creating method according to any of (6) through (8), as processing prior to a description length calculation performed in the description length calculating, the followings are further included: finding an average number of frames of a total number of frames of each state in respective HMM's having the present time Gaussian distribution number and a total number of frames of each state in respective HMM's having the immediately preceding Gaussian distribution number; and finding a normalized likelihood by normalizing the total likelihood of each state in respective HMM's having the present time Gaussian distribution number, and a finding normalized likelihood by normalizing the total likelihood of each state in respective HMM's having the immediately preceding Gaussian distribution number.

As has been described, by using the average number of frames of the total number of frames of all the states in respective HMM's having the present time Gaussian distribution number and the total number of frames of all the states in respective HMM's having the immediately preceding Gaussian distribution number, as the total number of frames to be substituted in Equation (2) above, and by using the total likelihood (normalized likelihood) normalized for each state in respective HMM's having the present time Gaussian distribution number, and the total likelihood (normalized likelihood) normalized for each state in respective HMM's having the immediately preceding Gaussian distribution number, as the total likelihood to be substituted in Equation (2) above, it is possible to find the description length of each state in respective HMM's more accurately.

(10) In the acoustic model creating method according to (1) through (9), it is preferable that the plural HMM's are syllable HMM's corresponding to respective syllables.

In the case of exemplary embodiments of the invention, by using syllable HMM's, advantages, such as a reduction in volume of computation, can be addressed and/or achieved. For example, when the number of syllables is 124, syllables outnumber phonemes (about 26 to 40). In the case of phoneme HMM's, however, a triphone model is often used as an acoustic model unit. Because the triphone model is constructed as a single phoneme by taking preceding and subsequent phoneme environments of a given phoneme into account, when all the combinations are considered, the number of models will reach several thousands. Hence, in terms of the number of acoustic models, the number of the syllable models is far smaller.

Incidentally, in the case of syllable HMM's, the number of states constituting respective syllable HMM's is about five in average for syllables including a consonant and about three in average for syllables comprising a vowel alone, thereby making a total number of states of about 600. In the case of a triphone model, however, a total number of states can reach several thousands even when the number of states is reduced by state tying among models.

Hence, by using syllable HMM's as HMM's, it is possible to address and/or reduce a volume of general computation, including, as a matter of course, the calculation to find the description lengths. It is also possible to address and/or achieve an advantage that the recognition accuracy comparable to that of triphone models can be obtained. As such, exemplary embodiments of the invention are applicable to phoneme HMM's.

(11) In the acoustic model creating method according to (10), for plural syllable HMM's having a same consonant or a same vowel among the syllable HMM's, of state constituting the syllable HMM's, initial states or plural states including the initial states in syllable HMM's are tied for syllable HMM's having the same consonant, and final states among states having self loops or plural states including the final states in syllable HMM's are tied for syllable HMM's having the same vowels.

The number of parameters can be thus reduced further, which enables a volume of computation and a quantity of used memories to be reduced further and the processing speed to be increased further. Moreover, the advantages of addressing and/or achieving the lower prices and the lower power consumption can be greater.

(12) An acoustic model creating apparatus of exemplary embodiments of the invention is an acoustic model creating apparatus that optimizes Gaussian distribution numbers for respective states constituting an HMM (hidden Markov Model) for each state, and thereby creates an HMM having optimized Gaussian distribution numbers, which is characterized by including: a distribution number setting device to increment a Gaussian distribution number step by step according to a specific increment rule for each state in plural HMM'S, and setting each state to a specific Gaussian distribution number; a matching data creating device to create matching data by matching each state in respective HMM's, which has been set to the specific Gaussian distribution number by the distribution number setting device, to training speech data; a description length calculating device to find, according to a Minimum Description Length criterion, a description length of each state in respective HMM's having a Gaussian distribution number at a present time to be outputted as a present time description length, and finding, according to the Minimum Description Length criterion, a description length of each state in respective HMM's having a Gaussian distribution number immediately preceding the present time to be outputted as an immediately preceding description length, with the use of the matching data created by the matching data creating device; and an optimum distribution number determining device to compare the present time description length with the immediately preceding description length in size, both of which are calculated by the description length calculating device, and setting an optimum Gaussian distribution number for each state in respective HMM's on the basis of a comparison result.

With the acoustic model creating apparatus, too, the same advantages as the acoustic model creating method according to (1) can be addressed or achieved.

(13) An acoustic model creating program of exemplary embodiments of the invention is an acoustic model creating program to optimize Gaussian distribution numbers for respective states constituting an HMM (hidden Markov Model) for each state, and thereby to create an HMM having optimized Gaussian distribution numbers, which is characterized by including: a distribution number setting procedural program for incrementing a Gaussian distribution number step by step according to a specific increment rule for each state in plural HMM's, and setting each state to a specific Gaussian distribution number; a matching data creating procedural program for creating matching data by matching each state in respective HMM's, which has been set to the specific Gaussian distribution number in the distribution number setting procedure, to training speech data; a description length calculating procedural program for finding, according to a Minimum Description Length criterion, a description length of each state in respective HMM's having a Gaussian distribution number at a present time to be outputted as a present time description length, and finding, according to the Minimum Description Length criterion, a description length of each state in respective HMM's having a Gaussian distribution number immediately preceding the present time to be outputted as an immediately preceding description length, with the use of the matching data created in the matching data creating procedure; and an optimum distribution number determining procedural program for comparing the present time description length with the immediately preceding description length in size, both of which are calculated in the description length calculating procedure, and setting an optimum Gaussian distribution number for each state in respective HMM's on the basis of a comparison result.

With the acoustic model creating program, too, the same advantages as the acoustic model creating method according to (1) can be addressed and/or achieved.

In the acoustic model creating method according to (12) or the acoustic model creating program according to (13), too, Equation (1) above can be used as an equation to find a description length of an HMM having the distribution number of an i'th kind among 1, . . . , i, . . . , I. Also, it is possible to use Equation (2) above, which is re-written from Equation (1) above. Herein, α in Equation (2) above is a weighting coefficient to obtain an optimum distribution number. Also, the data χ^{N} in Equation (1) above or Equation (2) above is a set of respective pieces of training speech data obtained by matching, for each state in time series, HMM's having an arbitrary distribution number among the given value through the maximum distribution number to many pieces of training speech data.

With the description length calculating device of the acoustic model creating apparatus according to (12) or in the description length calculating procedural program of the acoustic model creating program according to (13), a total number of frames and a total likelihood are found for each state in respective HMM's with the use of the matching data, for respective HMM's having the present time Gaussian distribution number, and the present time description length is found by substituting these in Equation (2) above, while a total number of frames and a total likelihood are found for each state in respective HMM's with the use of the matching data, for respective HMM's having the immediately preceding Gaussian distribution number, and the immediately preceding description length is found by substituting these in Equation (2) above.

With the optimum distribution number determining device of the acoustic model creating apparatus according to (12) or in the optimum distribution number determining procedural program of the acoustic model creating program according to (13), as a result of comparison of the present time description length with the immediately preceding description length, when the immediately preceding description length is smaller than the present time description length, the immediately preceding Gaussian distribution number is assumed to be an optimum distribution number for a state in question, and when the present time description length is smaller than the immediately preceding description length, the present time Gaussian distribution number is assumed to be a tentative optimum distribution number at this point in time for the state in question.

With the distribution number setting device of the acoustic model creating apparatus according to (12) or in the distribution number setting procedural program of the acoustic model creating program according to (13), for the state judged as having the optimum distribution number, the Gaussian distribution number is held at the optimum distribution number, and for the state judged as having the tentative optimum distribution number, the Gaussian distribution number is incremented according to the specific increment rule.

As processing prior to description length calculation processing performed by the description length calculating device of the acoustic model creating apparatus according to (12) or as processing prior to description length calculation processing performed in the description length calculating procedural program of the acoustic model creating program according to (13), processing to find an average number of frames of a total number of frames of each state in respective HMM's having the present time Gaussian distribution number and a total number of frames of each state in respective HMM's having the immediately preceding Gaussian distribution number, and processing to find a normalized likelihood by normalizing the total likelihood of each state in respective HMM's having the present time Gaussian distribution number, and to find a normalized likelihood by normalizing the total likelihood of each state in respective HMM's having the immediately preceding Gaussian distribution number, may be performed.

Further, the HMM's used in the acoustic model creating apparatus according to (12) or the acoustic model creating program according to (13) are preferably syllable HMM's. In addition, for plural syllable HMM's having a same consonant or a same vowel among the syllable HMM's, of state constituting the syllable HMM's, initial states or plural states including the initial states in syllable HMM's may be tied for syllable HMM's having the same consonant, and final states among states having self loops or plural states including the final states in syllable HMM's may be tied for syllable HMM's having the same vowels.

(14) A speech recognition apparatus of exemplary embodiments of the invention is a speech recognition apparatus to recognize an input speech, using HMM's (Hidden Markov Models) as acoustic models with respect to feature data obtained through feature analysis on the input speech, which is characterized in that HMM's created by the acoustic model creating method according to any of (1) through (11) are used as the HMM's used as the acoustic models.

As has been described, the speech recognition apparatus of exemplary embodiments of the invention uses acoustic models (HMM's) created by the acoustic model creating method of exemplary embodiments of the invention as described above. When HMM's are, for example, syllable HMM's, because each state in respective syllable HMM's has the optimum distribution number, the number of parameters in respective syllable HMM's can be reduced markedly in comparison with HMM's all having a constant distribution number, and the recognition ability can be thereby enhanced.

Also, because these syllable HMM's are Left-to-Right syllable HMM's of a simple structure, the recognition algorithm can be simpler, too, which can in turn reduce a volume of computation and a quantity of used memories. Hence, the processing speed can be increased and the prices and the power consumption can be lowered. It is thus possible to provide a speech recognition apparatus particularly useful for a compact, inexpensive system whose hardware resource is strictly limited.

### BRIEF DESCRIPTION OF THE DRAWINGS

FIG. 1 is a schematic view to explain an increment rule of the distribution number used in exemplary embodiments of the invention;

FIG. 2 is a flowchart detailing the acoustic model creating procedure in a first exemplary embodiment of the invention;

FIG. 3 is a schematic showing the configuration of an acoustic model creating apparatus in the first exemplary embodiment of the invention;

FIG. 4 schematically shows respective syllable HMM's belonging to a syllable HMM set having the distribution number M(1)=distribution number 1;

FIG. 5 is a flowchart detailing the processing (distribution number increment processing) in Step S3 of FIG. 2;

FIG. 6 is a flowchart detailing the processing (alignment data creating processing) in Step S4 of FIG. 2;

FIGS. 7A-C are schematics showing concrete examples of processing to match respective syllable HMM's to given training speech data in creating alignment data;

FIG. 8 is a flowchart detailing the processing (description length calculating processing) in Step S5 of FIG. 2;

FIGS. 9A-B are schematics showing a weighting coefficient α in Equation (2) above used in the invention;

FIG. 10 shows one example of alignment data A(2) obtained when the alignment data creating processing is performed with the use of syllable HMM's having the distribution number M(2)=distribution number 2 in the first exemplary embodiment and a second exemplary embodiment;

FIG. 11 shows one example of syllable label data;

FIG. 12 shows a likelihood calculation result for each state with respect to given training speech data in a syllable HMM belonging to a syllable HMM set having the distribution number M(2)=distribution 2, with the use of the alignment data A(2) in the first exemplary embodiment and the second exemplary embodiment;

FIG. 13 shows a collection result of a total number of frames and a total likelihood of respective syllable HMM's belonging to a syllable HMM set having the distribution number M(2)=distribution 2, with the use of the alignment data A(2) in the first exemplary embodiment and the second exemplary embodiment;

FIG. 14 shows the description length of each of the states, S0, S1, S2, and so on for respective syllables /a/, /i/, /u/, and so on for respective syllable HMM's belonging to a syllable HMM set having the distribution number M(2)=distribution number 2 obtained with the use of the alignment data A(2) in the case of the distribution number M(2)=distribution number 2 in the first exemplary embodiment and the second exemplary embodiment;

FIGs. A-B are schematics showing a calculation result of the description length for a syllable HMM set having the distribution number M(1)=1 and a calculation result of the description length for a syllable HMM set having the distribution number M(2)=distribution number 2, both with the use of the alignment data A(2), in the first exemplary embodiment and the second exemplary embodiment;

FIG. 16 is a flowchart detailing the acoustic model creating procedure in the second exemplary embodiment of the invention;

FIG. 17 is a schematic showing the configuration of an acoustic model creating apparatus in the second exemplary embodiment of the invention;

FIG. 18 is a flowchart detailing the acoustic model creating procedure in a third exemplary embodiment of the invention;

FIG. 19 is a schematic showing the configuration of an acoustic model creating apparatus in the third exemplary embodiment of the invention;

FIG. 20 is a flowchart detailing the processing (alignment data creating processing) in Step S44 of FIG. 18;

FIG. 21 shows alignment data A(3) and A(4) obtained with the use of respective syllable HMM's having the distribution number M(n−1)=the distribution number M(3)=distribution number 4, and the distribution number M(n)=the distribution number M(4)=distribution number 8, respectively, in the third exemplary embodiment;

FIG. 22 is a flowchart detailing the processing (average frame number calculating processing) in Step S45 of FIG. 18;

FIGS. 23A-C show a concrete example to calculate an average number of frames from total numbers of frames in the third exemplary embodiment;

FIG. 24 is a flowchart detailing the processing (normalized likelihood calculating processing and description length calculating processing) in Steps S46 and S47 of FIG. 18;

FIGS. 25A-B show a concrete example of a collection result of a total likelihood obtained from respective syllable HMM's having the distribution number M(n−1)=the distribution number M(3)=distribution number 4, and the distribution number M(n)=the distribution number M(4)=distribution number 8 in the third exemplary embodiment;

FIGS. 26A-B show complied data as to the total number of frames, the average number of frames, and the total likelihood found for each state in respective syllable HMM's in a case where a syllable HMM set having the distribution number M(n−1) is used and in a case where a syllable HMM set having the distribution number M(n) is used in the third exemplary embodiment;

FIGS. 27A-B show a result when the total likelihood (normalized likelihood) is added to the data of FIG. 26;

FIGS. 28A-B show a result when the description length is found with the use of the average number of frames and the normalized likelihood from the data of FIG. 27;

FIG. 29 is a schematic showing the configuration of a speech recognition apparatus of exemplary embodiments of the invention;

FIG. 30 is a schematic showing a state-tying in a fourth exemplary embodiment of the invention, describing a case where initial states or final states (final states in states having self loops) are tied in some syllable HMM's;

FIG. 31 is a schematic view showing that two connected-syllable HMM's, in which initial states are tied, are matched to given speech data;

FIG. 32 is a schematic showing the state-tying shown in FIG. 30, using an example case where plural states including the initial states or plural states including the final states are tied; and

FIG. 33 is a schematic showing a case where a syllable HMM is constructed by connecting a phoneme HMM of a consonant and a phoneme HMM of a vowel, and the distribution numbers for states in the phoneme HMM's of the vowel are tied in the case of distribution-tying.

### DETAILED DESCRIPTION OF PREFERRED EMBODIMENTS

Exemplary embodiments of the invention will now be described. The contents described in these exemplary embodiments include all the descriptions of an acoustic model creating method, an acoustic model creating apparatus, an acoustic model creating program, and a speech recognition apparatus of exemplary embodiments of the invention. Also, exemplary embodiments of the invention are applicable to both phoneme HMM's and syllable HMM's, but the exemplary embodiments below will describe syllable HMM's.

Exemplary embodiments of the invention are to optimize the Gaussian distribution number (hereinafter, referred to simply as the distribution number) for each of states constituting syllable HMM's corresponding to respective syllables (herein, 124 syllables). When the distribution number is optimized, the distribution number is incremented according to a specific increment rule from a given value to an arbitrary value. The increment rule can be set in various manners, and for example, it can be a rule that increments the distribution number by one step by step from 1 to 2, 3, 4, and so on. In exemplary embodiments described below, the description will be given on the assumption that the distributions number is incremented with the powers of 2: 1, 2, 4, 8, and so on. Also, 64 is given as the maximum distribution number in this exemplary embodiment.

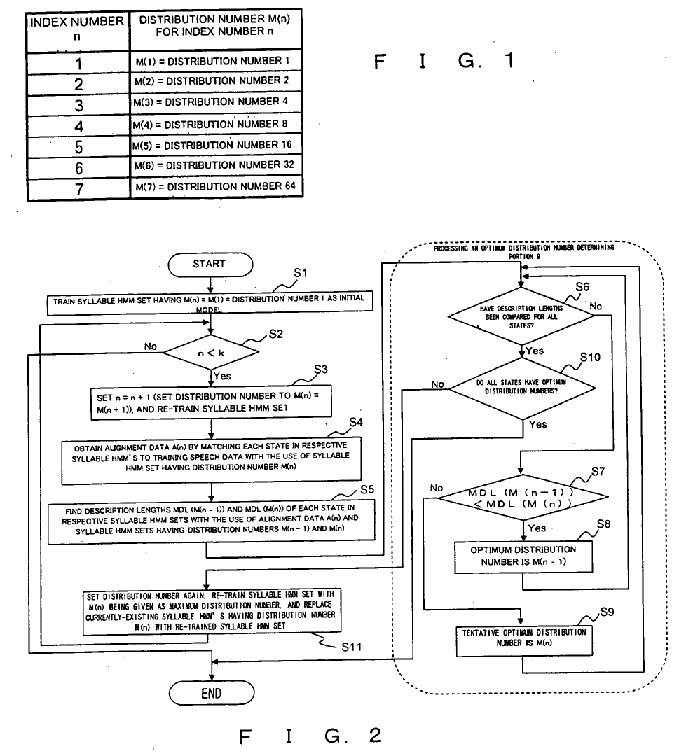

FIG. 1 shows the increment rule of the distribution number used to describe exemplary embodiments below, and shows index numbers n indicating the increment orders of the distribution number and the distribution number M(n) in connection with the index number n.

As can be understood from FIG. 1, given the index number n=1, the distribution number is M(n)=M(1), which specifies a distribution number 1; given the index number n=2, the distribution number is M(n)=M(2), which specifies a distribution number 2; given the index number n=3, the distribution number is M(n)=M(3), which specifies a distribution number 4; given the index number n=4, the distribution number is M(n)=M(4), which specifies a distribution number 8; given the index number n=5, the distribution number is M(n)=M(5), which specifies a distribution number 16; given the index number n=6, the distribution number is M(n)=M(6), which specifies a distribution number 32; and given the index number n=7, the distribution number is M(n)=M(7), which specifies a distribution number 64.

The index number n is equivalent to i in the model set {1, . . . , i, . . . I} in Equation (1) or Equation (2) above. In the exemplary embodiments, the maximum distribution number is 64, which means M(7)=distribution number 64. Hence, I in the model set {1, . . . , i, . . . I} is I=7.

In exemplary embodiments below, a relation between the index number and the distribution number is such that, as is shown in FIG. 1, for example, given the index number n=1, then the distribution number is M(1)=distribution number 1, given the index number n=2, then the distribution number is M(2)=distribution number 2, and so on.

### First Exemplary Embodiment

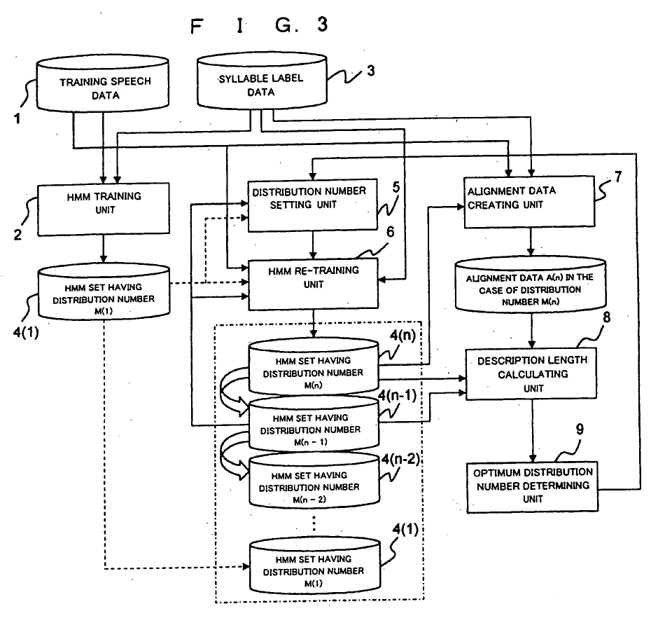

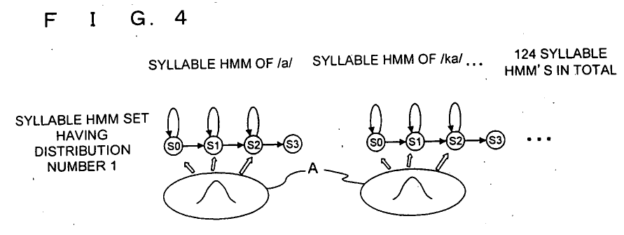

A first exemplary embodiment will now be described with reference to FIG. 1 through FIG. 15. An overall processing procedure of the first exemplary embodiment will be described first chiefly with reference to the flowchart of FIG. 2 and the view showing the configuration of FIG. 3.

As initial models of syllable HMM's, a set of syllable HMM's is constituted, in which the distribution number for each state in syllable HMM's corresponding to respective syllables is set as the distribution number M(1)=distribution number 1. An HMM training unit 2 then trains the set of syllable HMM's with the use of training speech data 1 including many pieces of training speech data and syllable label data 3 (in the syllable label data 3 are written syllable sequences that form respective pieces of training syllable data) through the maximum likelihood estimation method, and thereby creates a set of trained syllable HMM's (hereinafter, referred to as syllable HMM set 4 (1□ having the distribution number M(1)=distribution number 1 (Step S1).

Referring to the view showing the configuration of FIG. 3, arrows indicated by a dotted line (arrows indicating the flow of a signal) show the flow of data of the initial syllable HMM's (syllable HMM 4(1□ having the distribution number 1).

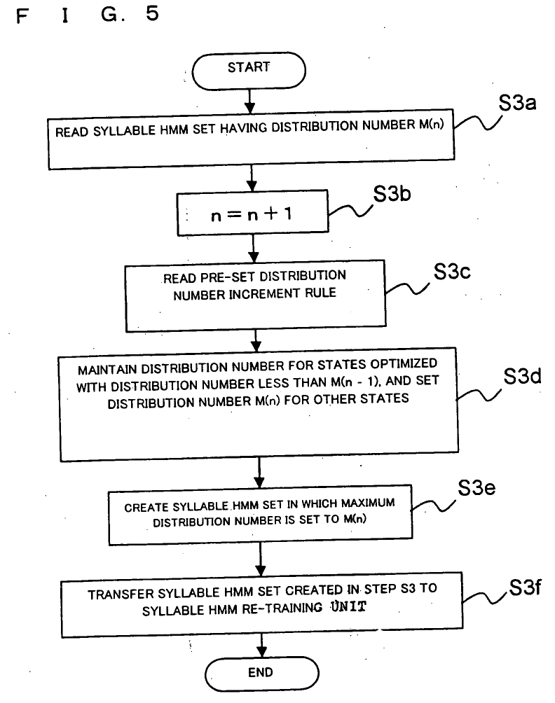

FIG. 4 is a schematic showing respective syllable HMM's (a syllable HMM of a syllable /a/, a syllable HMM of a syllable /ka/, and so on) belonging to the trained syllable HMM set 4(1) having the distribution number M(1)=distribution number 1. Referring to FIG. 4, for syllable HMM's corresponding to respective syllables and having the distribution number M(1)=distribution number 1, states having self loops include three states, S0, S1, and S2, and as is indicated by an elliptic frame A in the drawing, for each of these three states S0, S1, and S2, the distribution number M(1)=distribution number 1 is given at this point in time.

Referring to FIG. 2 again, whether the index number n at the present time has reached the maximum index number (herein, denoted as k) (n<k) is judged (Step S2). The processing ends when the index number n at the present time has reached the maximum index number. However, when n<k, a distribution number setting unit 5 sets the distribution number for each state in respective syllable HMM's belonging to the syllable HMM set 4(1) to n=n+1. That is, distribution number M(n)=M(n+1) is given and assumed to be a syllable HMM set at the present time (hereinafter, the syllable HMM set at present time is referred to as a syllable HMM set 4(n)). An HMM re-training unit 6 then re-trains respective syllable HMM's belonging to the syllable HMM set 4(n) (Step S3). At this point in time, a re-trained syllable HMM set having the distribution number M(2)=distribution number 2 is thus created.

The re-trained syllable HMM set having the distribution number M(n) (distribution number M(2)=distribution number 2 at this point in time) created in Step S3 is matched to respective pieces of training speech data 1 (the syllable label data 3 is used as well), and alignment data A(n) is created as matching data (Step S4). The alignment data A(n) is created by an alignment data creating unit 7 serving as matching data creating device, and the alignment data creating processing will be described below.

A description length calculating unit 8 calculates a total number of frames and a total likelihood of each of states that constitute individual syllable HMM's, for respective syllable HMM's belonging to a syllable HMM set 4(n−1) having the distribution number M(n−1), with the use of the alignment data A(n) created in Step S4, parameters of the syllable HMM set 4(n) having the distribution number M(n) at the present time, and parameters of the syllable HMM set (which is referred to as the syllable HMM set 4(n−1)) having the distribution number M(n−1) at a point immediately preceding the present time, and finds a description length MDL (M(n−1)) using the calculation result, as well as a total number of frames and a total likelihood of each of states constituting individual syllable HMM's, for respective syllable HMM's belonging to the syllable HMM set 4(n) having the distribution number M(n), with the use of the alignment data A(n) created in Step S4, and finds a description length MDL (M(n)) using the calculation result (Step S5). The description length calculating processing will be described below.

When the description length MDL (M(n)) in the case of the distribution number M(n) at the present time, that is, the distribution number M(2)=distribution number 2, as well as the description length MDL (M(n)) in the case of the distribution number M(n−1) at a point immediately preceding the present time (with the index number preceding by one), that is, the distribution number M(1)=distribution number 1, are found for each state in Step S5, an optimum distribution number determining unit 9 performs processing to determine an optimum distribution number by comparing the description length MDL (M(n)) with the description length MDL (M(n−1)) for each individual state (Steps S6 through S10). Hereinafter, the description length MDL (M(n−1)) is referred to as the immediately preceding description length, and the description length MDL (M(n)) is referred to as the present time description length for ease of explanation.

The optimum distribution number determining unit 9 performs, as the description length comparing processing, processing to judge whether MDL (M(n−1))<MDL (M(n)) is satisfied, with respect to the immediately preceding description length MDL (M(n−1)) and the present time description length (MDL (M(n)) for each state (Step S7). When the judgment result is MDL (M(n−1))<MDL (M(n)), that is, when the immediately preceding description length MDL (M(n−1)) is smaller than the present time description length (MDLM(n)), the distribution number M(n−1) is determined to be the optimum distribution number for a state in question (Step S8).

Conversely, when MDL (M(n−1))<MDL (M(n)) is not satisfied for a given state, that is, when the present time description length (MDL (M(n)) is smaller than the immediately preceding description length MDL (M(n−1)), the distribution number M(n) is determined to be a tentative optimum distribution number at this point in time for this state (Step S9).

Whether the description length comparing processing in Step S7 has ended for all the states is then judged (Step S6). When the description length comparing processing in Step S7 ends for all the states, whether the distribution numbers for all the states are judged as being optimum distribution numbers is judged (Step S10).

In other words, whether MDL (M(n−1))<MDL (M(n)) is satisfied for all the states is judged. When the distribution numbers for all the states are judged as being optimum distribution numbers from the judging result, the processing ends. A syllable HMM in question is thus assumed to be a syllable HMM in which all the states have the optimum distribution numbers (the distribution numbers are optimized).

Meanwhile, when it is judged that the distribution numbers for all the states are not optimum distribution numbers in Step S10, processing in Step S11 is performed. In Step S1, a syllable HMM set, in which the distribution numbers are set again with M(n) being given as the maximum distribution number, is re-trained and the syllable HMM set having the present time distribution number M(n) is replaced with this re-trained syllable HMM set.

To be more concrete, the processing in Step S11 is the processing as follows. For instance, of the states (herein, three states including states S0, S1, and S2) constituting a syllable HMM corresponding to a given syllable, assumed that the distribution number M(1)=distribution number 1 is determined to be the optimum distribution number for the state S0, the distribution number M(2)=distribution number 2 is determined to be a tentative optimum distribution number for the state S1, and the distribution number M(2)=distribution number 2 is also determined to be a tentative optimum distribution number for the state S2. Then, the distribution numbers of each of the states S0, S1, and S2 in this syllable HMM are set again in such a manner that M(1)=distribution number 1 is the distribution number for the state S0, M(2)=distribution number 2 is the distribution number for the state S1, and M(2)=distribution number 2 is the distribution number for the state S2. This syllable HMM is re-trained with the use of the training speech data 1 and the syllable label data 3 with the distribution number M(2)=distribution number 2 being given as the maximum distribution number, and the currently-existing syllable HMM (a syllable HMM in which all the states have the distribution number M(2)=distribution number 2) is replaced with the re-trained syllable HMM. This processing is performed for syllable HMM's corresponding to all the syllables.

When the processing in Step S11 ends, the flow returns to Step S2 and the same processing is repeated as described above. To be more concrete, whether the index number n has reached the set value k (k=7 in this exemplary embodiment) is judged first. However, because n at this point in time is n=2, that is, n<k, the distribution number setting unit 5 sets n=n+1 (the distribution number M(3)=distribution number 4), and the syllable HMM set having the distribution number 4 is re-trained.

In this instance, for the states judged as having the optimum distribution numbers in the description length comparing processing in Step S7, the distribution numbers at the time of judgment are maintained. Whether the distribution number has been set to an optimum distribution number for a state in question is judged for each state by a method of creating a table written with information indicating that the distribution number has been optimized for each individual state and referring to the table, or a method of making the judgment from the structures of respective syllable HMM's.

The syllable HMM set having the distribution number M(3)=distribution number 4 is matched to the training speech data 1 with the use of the syllable label data 3 to create alignment data A(3). With the use of this alignment data A(3) and the syllable HMM sets having the immediately preceding distribution number M(2)=distribution number 2 and the present time distribution number M(3)=distribution number 4, the immediately preceding description length MDL (M(n−1)), that is, MDL (M(2)), and the present time description length MDL (M(n)), that is, MDL (M(3)), are found for each state in respective syllable HMM's.

When the present time description length MDL (M(n)) and the immediately preceding description length MDL (M(n−1)), which is earlier by one point in time, are found in this manner, whether MDL (M(n−1))<MDL (M(n)) is satisfied is judged in the same manner as described above (Step S7). When it is judged that the immediately preceding description length is smaller than the present time description length from the judging result, the distribution number M(n−1) is assumed to be the optimum distribution number for a state in question (Step S8).

Conversely, when whether MDL (M(n−1))<MDL (M(n)) is satisfied is judged for a given state (Step S7), and it is judged that MDL (M(n−1))<MDL (M(n)) is not satisfied from the result, that is, when the present time description length is smaller than the immediately preceding description length, the distribution number M(n) is assumed to be a tentative optimum distribution number at this point in time for this state (Step S9).

Subsequently, whether the description length comparing processing in Step S7 has ended for all the states, is judged (Step S6). When the description length comparing processing in Step S7 ends for all the states, whether the distribution numbers for all the states are optimum distribution numbers, is judged (Step S10).

In other words, whether MDL (M(n−1))<MDL (M(n)) is satisfied for all the states is judged. When the distribution numbers for all the states are judged as being optimum distribution numbers from the judging result, a syllable HMM in question is then assumed to be a syllable HMM in which all the states have the optimum distribution numbers (the distribution numbers are optimized).

Meanwhile, when it is judged that the distribution numbers for all the states are not the optimum distribution numbers in Step S10, processing in Step S11 is performed. In Step S11, as has been described, a syllable HMM set, in which the distribution numbers are set again with M(n) being given as the maximum distribution number, is re-trained and the currently-existing syllable HMM set having the distribution number M(n) is replaced with this re-trained syllable HMM set. Then, the flow returns to Step S2, and the same processing is repeated.

By performing the processing as described above recursively, it is possible to obtain a syllable HMM, in which each state has the optimum distribution number, for respective syllable HMM's.

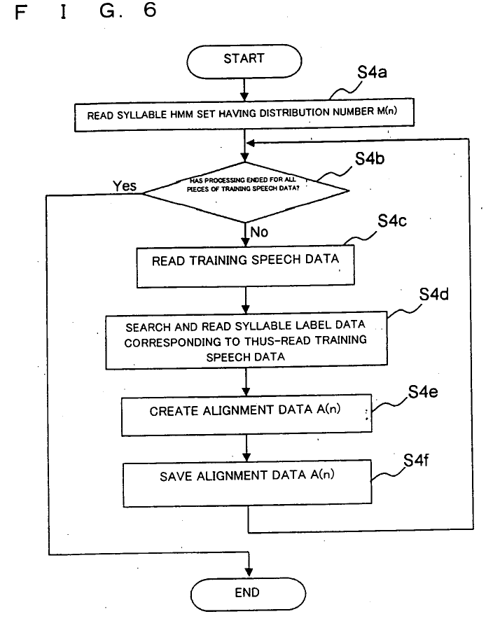

FIG. 5 shows the procedure of the processing (distribution number increment processing performed by the distribution number setting unit 5) in Step S3 of FIG. 2. Referring to FIG. 5, a given syllable HMM that is set to have the present time distribution number M(n) is read first (Step S3a), and the index number n is set to n+1 (Step S3b), after which the pre-set increment rule of the distribution number (the increment rule such as the one shown in FIG. 1 in this exemplary embodiment) is read (Step S3c).

For the states whose distribution numbers have been set to the optimum distribution numbers, the optimum numbers are maintained as the distribution numbers. For the other states, the distribution numbers are set to the distribution numbers M(n) according to the increment rule (Step S3d). Then, a syllable HMM set is created, in which each state has been set to the distribution number set in Step S3d (Step S3e), and the syllable HMM set thus created is transferred to the HMM re-training unit 6 (Step S3f).

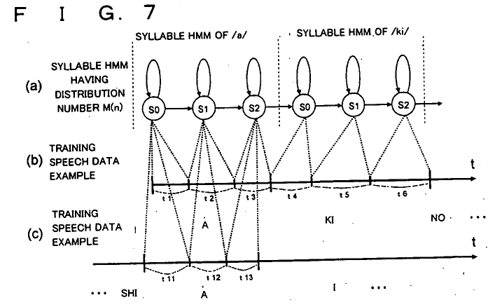

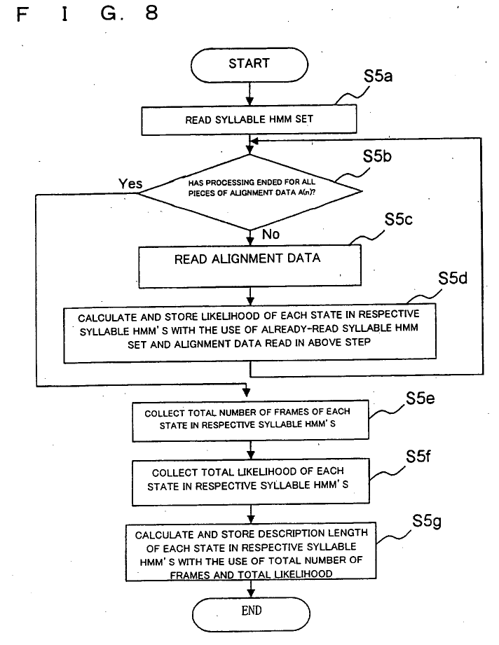

FIG. 6 is a flowchart detailing the processing procedure of the processing (alignment data creating processing by the alignment data creating unit 7) in Step S4 of FIG. 2. Referring to FIG. 6, a syllable HMM set having the distribution number M(n) is read first (Step S4a), and whether the alignment data creating processing has ended for all pieces of the training speech data 1 is judged (Step S4b). When the processing has not ended for all pieces of the training speech data, one piece of data is read from the training speech data for which the processing has not ended (Step S4c), and the syllable label data corresponding to the training speech data thus read is searched through and read from the syllable label data 3 (Step S4d). The alignment data A(n) is then created through the Viterbi algorithm with the use of all the syllable HMM's belonging to the syllable HMM set having the distribution number M(n), the training speech data, and the corresponding syllable label data (Step S4e), and the alignment data A(n) thus created, is saved (Step S4f). The alignment data creating processing will be described with reference to FIG. 7.

FIG. 7 is a schematic showing a concrete example of the processing to match respective syllable HMM's belonging to the syllable HMM set in which the respective states have been set to a given distribution number (the distribution number may differ from state to state) to the training speech data 1 in creating the alignment data.

With the use of all pieces of the training speech data 1 and a syllable HMM set having a given distribution number (the distribution number M(n) set at the present time in the first exemplary embodiment), as are shown in FIG. 7(a), FIG. 7(b), and FIG. 7(c), the alignment data creating unit 7 takes alignment of each of the states S0, S1, and S2 in respective syllable HMM's of the syllable HMM set and the training speech data 1.

For example, as is shown in FIG. 7(b), when matching is performed on a training speech data example, “AKINO (autumn) . . . ”, as one training speech data example among the training speech data 1, matching is performed on the training speech data example, “A”, “K1”, “NO”, . . . , in such a manner that the state S0 in a syllable HMM of a syllable /a/ matches to an interval t1 of the training speech data, the state S1 in the syllable HMM of the syllable /a/ matches to an interval t2 of the training speech data example, and the state S2 in the syllable HMM of the syllable /a/ matches to an interval t3 of the training speech data example. The matching data thus obtained is used as the alignment data.

Likewise, matching is performed in such a manner that the state S0 in a syllable HMM of a syllable /ki/ matches to an interval t4 of the training speech data example shown in FIG. 7(b), the state S1 in the syllable HMM of the syllable /ki/ matches to an interval t5 of the training speech data example, and the state S2 in the syllable HMM of the syllable /ki/ matches to an interval t6 of the training speech data example, and the matching data thus obtained is used as the alignment data.

In this instance, the frame number of a start frame and the frame number of an end frame of a data interval are obtained for each matching data interval as a piece of the alignment data.

Also, as is shown in FIG. 7(c), matching is performed on a training speech data example, “ . . . SHIAI (game) . . . ”, as another training speech data example, in such a manner that the state S0 in a syllable HMM of a syllable /a/ having the state number 3 matches to an interval t11 of the training speech data example, the state S1 in the syllable HMM of the syllable /a/ matches to an interval t12 of the training speech data example, and the state S2 in the syllable HMM of the syllable /a/ matches to an interval t13 of the training speech data example, and the matching data thus obtained is used as the alignment data. As with the foregoing example, the frame number of a start frame and the frame number of an end frame of a data interval are obtained for each matching data interval as a piece of the alignment data.

With the use of the alignment data A(n) thus created in the alignment data creating unit 7, the description length calculating unit 8 finds the description length of each state.

In the first exemplary embodiment, parameters of the respective syllable HMM's belonging to the syllable HMM set that has been set to have the present time distribution number M(n), parameters of the respective syllable HMM's belonging to the syllable HMM set that has been set to have the immediately preceding distribution number M(n−1), the training speech data 1, and the alignment data A(n) are provided to the description length calculating unit 8. The description length is then calculated for each state in respective syllable HMM's. The states for which the optimum distribution numbers have been maintained are not subjected to the description length calculation.

The description length calculating unit 8 then finds the description length (present time description length) of each state (excluding the states for which the optimum distribution numbers have been set) in respective syllable HMM's belonging to the syllable HMM set that has been set to have the present time distribution number M(n), and the description length (immediately preceding description length) of each state (excluding the states for which the optimum distribution numbers have been set) in respective syllable HMM's belonging to the syllable HMM set that has been set to have the immediately preceding distribution number M(n−1).

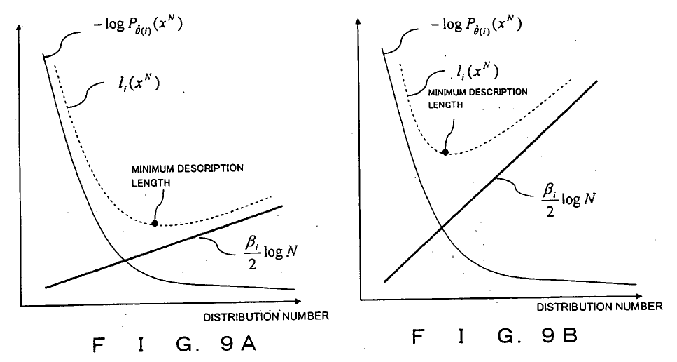

FIG. 8 is a flowchart detailing the procedure of the description length calculating processing performed by the description length calculating unit 8, which is a detailed description of the processing in Step S5 of FIG. 2.

Referring to FIG. 8, a syllable HMM set to be processed (the syllable HMM set having the distribution number M(n−1) or the distribution number M(n)) is read first (Step S5a), and whether the processing has ended for all pieces of the alignment data A(n) is judged (Step S5b). When it is judged that the processing has not ended for all pieces of the alignment data A(n) from the judging result, a piece of alignment data is read from alignment data in the case of the distribution number M(n−1) or the distribution number M(n) for which the processing has not ended (Step S5c).

With the use of the syllable HMM set read in Step S5a and the alignment data read in Step S5b, the likelihood is calculated for each state in respective syllable HMM's, and the calculation result is stored (Step S5d). This processing is performed for all pieces of the alignment data A(n). When the processing ends for all pieces of the alignment data A(n), a total frame number is collected for each state in the respective syllable HMM's, and a total likelihood is also collected for each state in respective syllable HMM's (Steps S5e and S5f).

With the use of the total frame number and the total likelihood, the description length is calculated for each state in respective syllable HMM's, and the description length is stored (Step S5g).

The MDL (Minimum Description Length) criterion used in exemplary embodiments of the invention will now be described. The MDL criterion is a technique described in, for example, related art document HAN Te-Sun, Iwanami Kouza Ouyou Suugaku 11, Jyouhou to Fugouka no Suuri, IWAMAMI SHOTEN (1994), pp. 249-275. As has been described above, when a model set {1, . . . , i, . . . , I} and data χ^{N}={χ₁, . . . , χ_{N}} (where N is a data length) are given, the description length li(χ^{N}) using a model i is defined as Equation (1), and according to the MDL criterion, the description length li(χ^{N}).

The MDL (Minimum Description Length) criterion used in exemplary embodiments of the invention will now be described. The MDL criterion is a technique described in, for example, related art document HAN Te-Sun, Iwanami Kouza Ouyou Suugaku 11, Jyouhou to Fugouka no Suuri, IWAMAMI SHOTEN (1994), pp. 249-275. As has been described above, when a model set {1, . . . , i, . . . , I} and data χ^{N}={χ₁, . . . , χ_{N}} (where N is a data length) are given and a model i is used, a model whose description length li(χ) is a minimum is assumed to be an optimum model.

In exemplary embodiments of the invention, a model set {1, . . . , i, . . . , I} is thought to be a set of states in a given HMM whose distribution number is set to plural kinds from a given value to the maximum distribution number. Let I kinds (I is an integer satisfying I≧2) be the kinds of the distribution number when the distribution number is set to plural kinds from a given value to the maximum distribution number, then 1, . . . , i, . . . , I are codes to specify the respective kinds from the first kind to the I'th kind. Hence, Equation (1) above is used as an equation to find the description length of a state having the distribution number of the i'th kind among 1, . . . , i, . . . , I.

I in 1, . . . , i, . . . , I stands for a sum of HMM sets having different distribution number. That is, I indicates how many kinds of distribution numbers are present. In this exemplary embodiment, seven kinds of models having distribution numbers 1, 2, 4, 8, 16, 32, and 64 are created in the end. However, I=2, because HMM sets subjected to the description length calculation in the description length calculation unit 8 of FIG. 3 are always two kinds of HMM sets: an HMM set having the distribution number M(n−1) and an HMM set having the distribution number M(n).

Because 1, . . . , i, . . . , I are codes to specify any kind from the first kind to the I'th kind as has been described, in a case of this exemplary embodiment, of 1, . . . , i, . . . , I, 1 is given to the distribution number M(n−1) as a code indicating the kind of the distribution number, thereby specifying that the distribution number is of the first kind.

Also, of 1, . . . , i, . . . , I, 2 is given to the distribution number M(n) as a code indicating the kind of the distribution number, thereby specifying that the distribution number is of the second kind.

When consideration is given to syllable HMM's of a syllable /a/, in this exemplary embodiment, a set of the states S0 having two kinds of distribution numbers from the distribution number M(n−1) to the distribution number M(n) form one model set. Likewise, a set of the states S1 having two kinds of distribution numbers from the distribution number M(n−1) to the distribution number M(n) form one model set, and a set of the states S2 having two kinds of distribution numbers from the distribution number M(n−1) to the distribution number M(n) form one model set.

Hence, in exemplary embodiments of the invention, for the description length li(χ^{N}) defined as Equation (1), Equation (2), which is a rewritten form of Equation (1), is used on the assumption that it is the description length li(χ^{N}) of the state (referred to as the state i) when the kind of the distribution number for a given state is set to the itth kind among 1, . . . , i, . . . , I.

In Equation (2), log I in the third term, which is the final term on the right side of Equation (1), is omitted because it is a constant, and that (β/2)log N, which is the second term on the right side of Equation (1), is multiplied by a weighting coefficient α. In Equation (2), log I in the third term, which is the final term on the right side of Equation (1), is omitted; however, it may not be omitted and left intact.

Also, βi is a dimension (the number of free parameters) of the state i having the i'th distribution number as the kind of the distribution number, and can be expressed by: distribution number×dimension number of feature vector. Herein, the dimension number of the feature vector is: cepstrum (CEP) dimension number+Δ cepstrum (CEP) dimension number+Δ power (POW) dimension number.

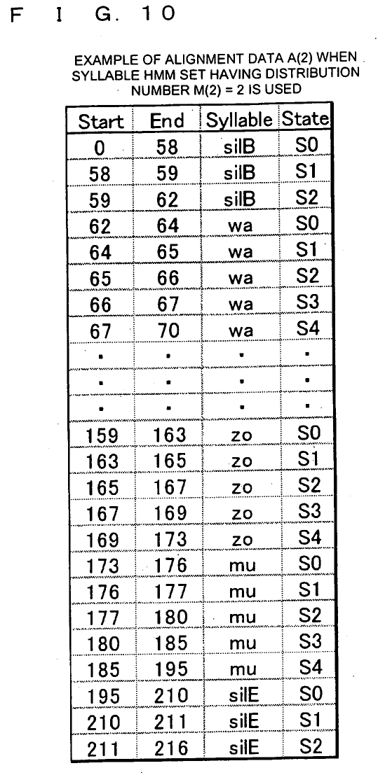

Also, α is a weighting coefficient to adjust the distribution number to be optimum, and the description length li(χ^{N}) can be changed by changing α. That is to say, as are shown in FIG. 9A and FIG. 9B, in very simple terms, the value of the first term on the right side of Equation (2) decreases as the distribution number increases (indicated by a fine solid line), and the second term on the right side of Equation (2) increases monotonously as the distribution number increases (indicated by a thick solid line). The description length li(χ^{N}), found by a sum of the first term and the second term, therefore takes values indicated by a broken line.

Hence, by making a variable, it is possible to make a slope of the monotonous increase of the second term variable (the slope becomes larger as a is made larger). The description length li(χ^{N}), found by a sum of the first term and the second term on the right side of Equation (2), can be thus changed by changing the value of a. Hence, FIG. 9A is changed to FIG. 9B by, for example, making a larger, and it is therefore possible to adjust the description length li(χ^{N}) to be a minimum when the distribution number is smaller.

The state i having the i'th kind distribution number in Equation (2) corresponds to M pieces of data (M pieces of data comprising a given number of frames). That is to say, let n1 be the length (the number of frames) of data 1, n2 be the length (the number of frames) of data 2, and nM be the length (the number of frames) of data M, then N of χ^{N} is expressed as: N=n1+n2+ . . . +nK. Thus, the first term on the right side of Equation (2) is expressed by Equation (3) set forth below.

Data 1, data 2, . . . , and data K referred to herein mean data corresponding to a given interval in many pieces of training speech data 1 matched to the state i (for example, as has been described with reference to FIG. 7, training speech data matched to the interval t1 or the interval t11 on the assumption that the state i is the state S0 in an HMM of a syllable /a/ having a given distribution number).
log P_{\hat{θ}(i)}(x^{N})=log P_{\hat{θ}(i)}(xⁿ^{₁})+log P_{\hat{θ}(i)}(xⁿ^{₂})+ . . . +log P_{\hat{θ}(i)}(xⁿ^{_{M}}) (3)

In Equation (3), respective terms on the right side are likelihoods of the matched training speech data intervals when the state i having the i'th kind distribution number are matched to respective pieces of training speech data. As can be understood from Equation (3), the likelihood of the state i having the i'th distribution number is expressed by a sum of likelihoods of respective pieces of training speech data matched to the state i.

Hence, in this exemplary embodiment, Step S5 in the flowchart described with reference to FIG. 2, that is, the description length calculating processing performed by the description length calculating unit 8 of FIG. 3 is the processing to calculate Equation (2).

Incidentally, in Equation (2), because the first term on the right side stands for a total likelihood of a given state, and N in the second term on the right side stands for a total number of frames, it is possible to find the description length of a state set to a given distribution number by substituting the total likelihood and the total frame number, which are found for each state, in Equation (2).

Hereinafter, a concrete description will be given through an experiment example conducted by the inventor of the invention.

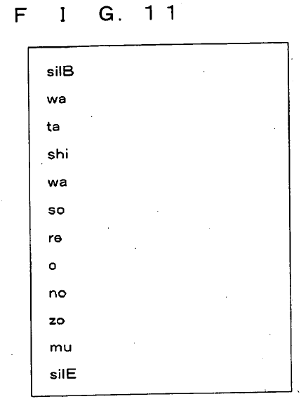

FIG. 10 shows one example of the alignment data A(2) obtained when a given training speech data example (hereinafter, referred to as the training speech data example 1a), “wa ta shi wa so re o no zo mu (I want it)” was matched to syllable HMM's belonging to a syllable HMM set having the distribution number M(2)=distribution number 2.

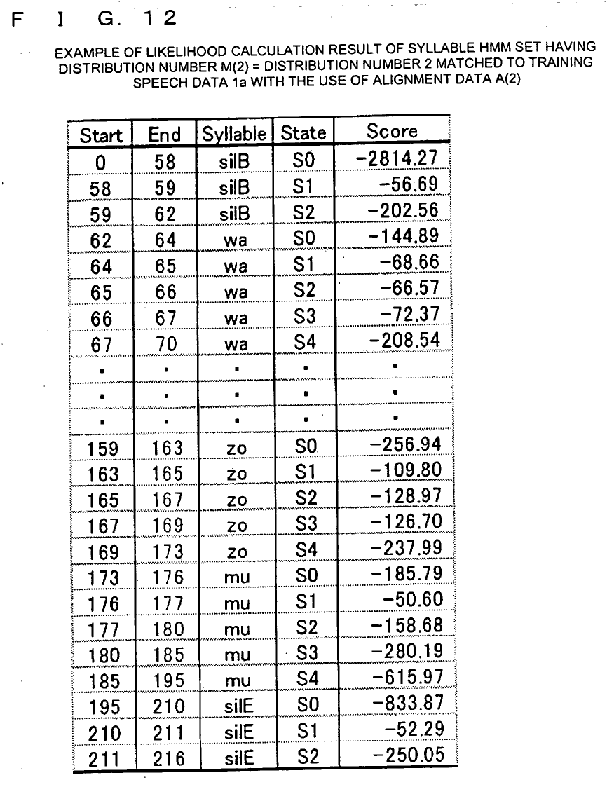

When the alignment data is created, the syllable label data (hereinafter, referred to as the syllable label data example 3a) corresponding to the training speech data 1a is used. The syllable label data example 3a has contents as are shown in FIG. 11. Referring to FIG. 11, SilB is a syllable indicating a speech interval equivalent to a silent unit present at the beginning of utterance, and SilE is a syllable indicating a speech interval equivalent to a silent unit present at the end of utterance.

Such a syllable label data example is prepared for all pieces of the training speech data 1. Herein, the number of pieces of the prepared training speech data 1 is about 20000.

Incidentally, in the alignment data A(2) shown in FIG. 10, a start frame number (Start) indicating the start frame and the end frame number (End) indicating the end frame are written for each state (State) in syllable HMM's corresponding to respective syllables (Syllable) constituting given training speech data 1a (“wa ta shi wa so re o no zo mu”).

In this experiment, syllable HMM's corresponding to a syllable /SilB/ indicating a silent unit present at the beginning, a syllable /SilE/ indicating a silent unit present at the end, syllables comprising vowels alone (/a/, /i/, /u/, /e/, and /o/), syllables indicating a choked sound and a syllabic nasal (/q/ and /N/), and a syllable indicating a silent unit present between utterances (/sp/), have three states, S0, S1, and S2, and Syllable HMM's corresponding to other syllables including consonants (/ka/, /ki/, and so on) have five states, S0, S1, S2, S3, and S4.

The example of the alignment data A(2) shown in FIG. 10 is for the training speech data 1a, “wa ta shi wa so re o no zo mu”. It should be noted, however, that alignment data A(2) as shown in FIG. 10 is created for all pieces of the training speech data 1. As has been described, given the present time distribution number M(n), then the alignment data A(2) is the alignment data created by matching, for example, respective syllable HMM's belonging to a syllable HMM set having the distribution number M(2)=distribution number 2 to respective pieces of training speech data 1. The likelihood can be found when the alignment data is created; however, it is sufficient to obtain information as to the start frame number and the end frame number in this instance.

With the use of this alignment data A(2), the description length calculating unit 8 first calculates the likelihood frame by frame (from the start frame to the end frame) obtained by the matching, for each state in respective syllable HMM's belonging to this syllable HMM set.

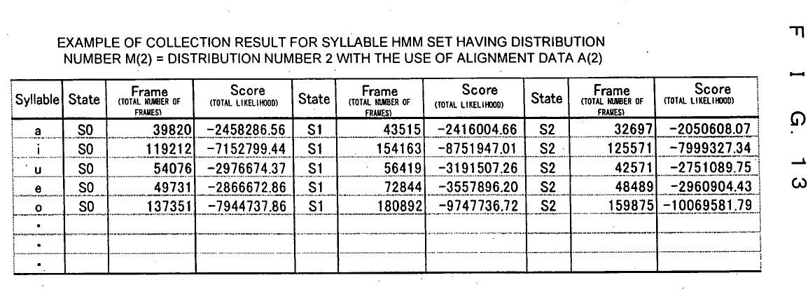

For example, FIG. 12 shows a result when the likelihood is calculated for each frame (from the start frame to the end frame) in each state (State) with respect to training speech data 1a (training speech data, “wa ta shi wa so re o no zo mu) for individual syllable HMM's among all the syllable HMM's belonging to the syllable HMM set having the distribution number M(2)=distribution number 2. Referring to FIG. 12, “Score” stands for the likelihood of each state in respective syllable HMM's.

The likelihood calculation result set forth in FIG. 12 is found for the training speech data 1a in the case of the distribution number M(2)=2 with the use of the alignment data A(2). However, the likelihood calculation is performed for all pieces of the training speech data 1, and it is thus possible to obtain the likelihood calculation result for all pieces of the training speech data 1.

When the likelihood calculation result for all pieces of the training speech data 1 is obtained, a total frame number and a total likelihood are collected for each of the states S0, S1, S2, and so on for each of syllables /a/, /i/, /u/, /e/, and so on.

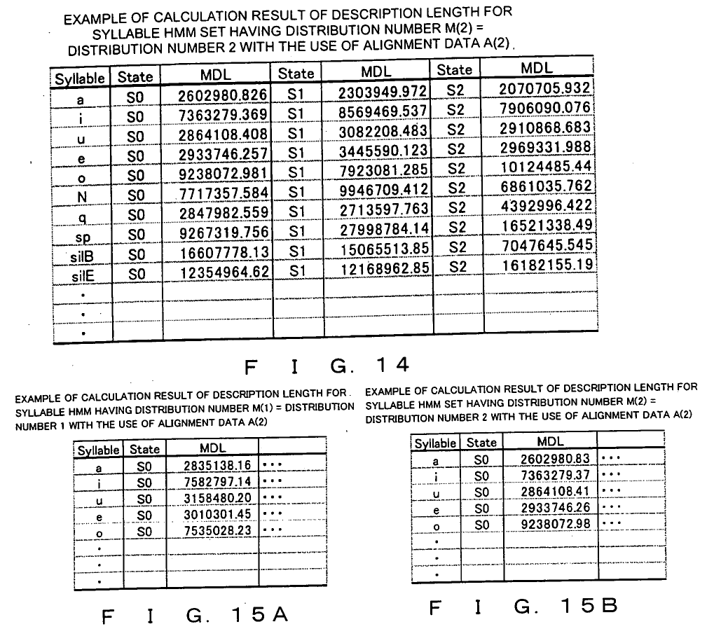

FIG. 13 shows one example of the collection result of the total number of frames and the total likelihood in a syllable HMM set having the distribution number M(2)=2, with the use of the alignment data A(2) obtained by matching respective syllable HMM's belonging to the syllable HMM set having the distribution number M(2)=distribution number 2 to respective pieces of training speech data 1. Referring to FIG. 13, “Frame” stands for the total number of frames, and “Score” stands for the total likelihood.

When the total number of frames and the total likelihood of each state in respective syllable HMM's belonging to the syllable HMM set having the distribution number M(2)=2 are found for all the syllables as described above, the description length is calculated from the result set forth in FIG. 13 and Equation (2).

To be more specific, in Equation (2) to find the description length li (χ^{N}), the first term on the right side is equivalent to a total likelihood, and N in the second term on the right side is equivalent to a total number of frames. Hence, a total likelihood set forth in FIG. 13 is substituted in the first term on the right side, and a total number of frames set forth in FIG. 13 is substituted for N in the second term on the right side.

For example, when the foregoing is considered using a syllable /a/, as can be understood from FIG. 13, for the state S0, a total number of frames is “39820” and a total likelihood is “−2458286.56”. Accordingly, the total number of frames, “39820”, is substituted for N in the second term on the right side and a total likelihood, “−2458286.56”, is substituted in the first term on the right side.

Herein, β in Equation (2) is a dimension number of a model, and it can be found by: distribution number×dimension number of feature vector. In this experiment example, 25 is given as the dimension number of the feature vector (cepstrum is 12 dimensions, delta cepstrum is 12 dimensions, and delta power is 1 dimension). Hence, β=25 in the case of the distribution number M(1)=distribution number 1, β=50 in the case of the distribution number M(2)=distribution number 2, and β=100 in the case of the distribution number M(3)=distribution number 4. Herein, 1.0 is given as the weighting coefficient α.

Hence, the description length (indicated by L(a, 0)) of the state S0 for a syllable /a/ when a syllable HMM having the distribution number M(2)=distribution number 2 is used can be found by: L(a, 0)=2458286.56+1.0×(50/2)×log(39820)=2602980.83 . . . (4). Because a total likelihood is found as a negative value (see FIG. 13) and a negative sign is appended to the first term on the right side of Equation (2), a total likelihood is expressed as a positive value.

Likewise, the description length (indicated by L(a, 1)) of the state S1 for a syllable /a/ when a syllable HMM having the distribution number M(2)=distribution number 2 is used can be found by: L(a, 1)=2416004.66+1.0×(50/2)×log(43515)=2303949.97 . . . (5).

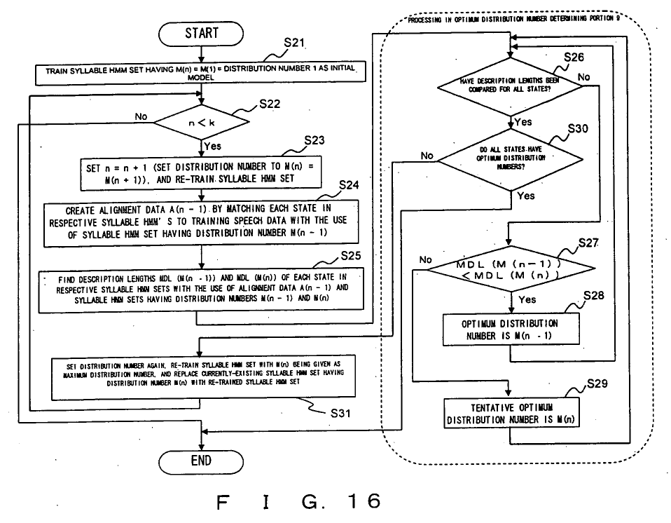

In this manner, the description length is calculated for each state in syllable HMM's corresponding to all syllables (124 syllables). An example of the calculation result is shown in FIG. 14.

FIG. 14 shows an example of the description length calculation result in a syllable HMM set having the distribution number M(2)=2 with the use of the alignment data A(2), and shows the description lengths calculated for each of the states, S0, S1, S2, and so on for all the syllables /a/, /i/, /u/, and so on. Referring to FIG. 14, “MDL” stands for the description length.

The processing to calculate the description length is the processing in Step S5 of FIG. 2. In Step S5, the description length (immediately preceding description length) in the case of the immediately preceding distribution number M(n−1), which is earlier by one point in time than the present time, is calculated with the use of the alignment data A(n), and the description length (present time description length) in the case of the present time distribution number M(n) is calculated with the use of the same alignment data A(n).

For example, in a case where the present time distribution number is M(2), assume that the description lengths of a given state (for example, state S0) having the distribution number M(1) at a point immediately preceding the present time are found as are set forth in FIG. 15A, and the description lengths of the state S0 having the present time distribution number M(2) are found as are set forth in FIG. 15B, both with the use of the alignment data A(2). FIG. 15B shows the same description lengths found for the states S0 in FIG. 14.

With the use of the description lengths set forth in FIG. 15A and FIG. 15B, the comparing and judging processing of the description lengths, that is, as to whether MDL (M(n−1))<MDL (M(n)) is satisfied, in Step S7 of FIG. 2, is performed. In this case, the description length MDL of FIG. 15A is equivalent to MDL (M(n−1)), and the description length MDL of FIG. 15B is equivalent to MDL (M(n)).

It is understood from FIG. 15A and FIG. 15B that in the state S0, the values of the description lengths are smaller in the case of the distribution number M(n)=the distribution number M(2)=distribution number 2 for each of syllables /a/, /i/, /u/, and /e/, and the value of the description length is smaller in the case of the distribution number M(n−1)=the distribution number M(1)=distribution number 1 only for a syllable /o/.

That is to say, for the states S0 in respective syllable HMM's corresponding to the syllables /a/, /i/, /u/, and /e/, the distribution number M(2)=distribution number 2 is judged as being a tentative optimum distribution number at this point in time.

Meanwhile, for the state S0 in syllable HMM's corresponding to the syllable /o/, the distribution number M(1)=distribution number 1 is judged as being the optimum distribution number.

Hence, for the state S0 in syllable HMM's corresponding to the syllable /o/, the distribution number M(1)=distribution number 1 is judged as being the optimum distribution number, and the state S0 is held at the distribution number 1. The distribution number increment processing is thus no longer performed for the state S0. Meanwhile, for the states S0 in respective syllable HMM's corresponding to the syllables /a/, /i/, /u/, and /e/, the distribution number is incremented in correspondence with the index number, which is repeated until MDL (M(n−1))<MDL (M(n)) is satisfied.

Then, whether the distribution numbers are optimal distribution numbers is judged for each state in all syllable HMM's (Step S10 in FIG. 2), that is, whether MDL (M(n−1))<MDL (M(n)) is satisfied for all the states in a given syllable HMM is judged. When it is judged that the distribution numbers are optimum distribution numbers for all the states in this syllable HMM, this syllable HMM is assumed to be a syllable HMM in which all the states have optimum distribution numbers (the distribution numbers are optimized). The foregoing is performed for all the syllable HMM's.

For respective syllable HMM's created through the processing described above, the distribution number is optimized for each state in individual syllable HMM's. It is thus possible to secure high recognition ability. Moreover, when compared with a case where the distribution number is the same for all the states, it is possible to reduce the number of parameters markedly. Hence, a volume of computation and a quantity of used memories can be reduced, the processing speed can be increased, and further, the prices and power consumption can be lowered.

Also, in exemplary embodiments of the invention, the distribution number for each state in respective syllable HMM's is incremented step by step according to the specific increment rule to find the present time description length MDL (M(n)) and the immediately preceding description length MDL (M(n−1)), which are compared with each other. When MDL (M(n−1))<MDL (M(n)) is satisfied, the distribution number at this point in time is maintained, and the processing to increment the distribution number step by step is no longer performed for this state. It is thus possible to set the distribution number efficiently to the optimum distribution number for each state.

### Second Exemplary Embodiment

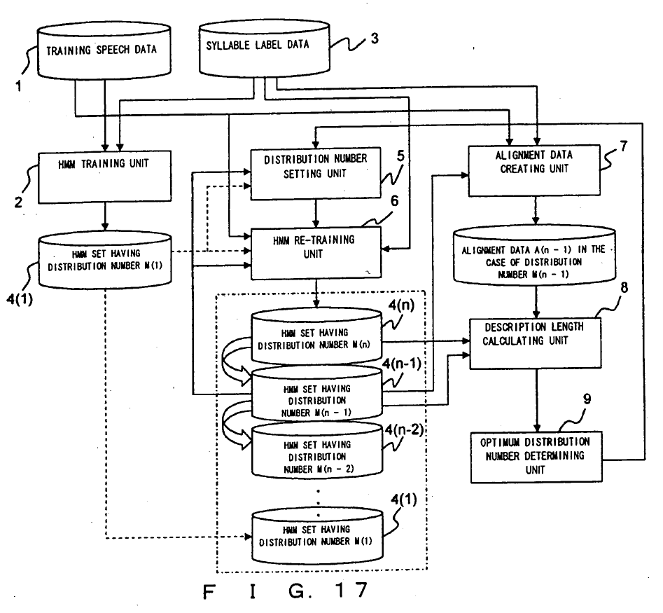

The first exemplary embodiment has described the matching of the states in respective syllable HMM's to the training speech data performed by the alignment data creating unit 7 through an example case where the alignment data A(n) is created by matching respective syllable HMM'S belonging to a syllable HMM set having the present time distribution number, that is, the distribution number M(n), to respective pieces of training speech data 1. However, exemplary embodiments of the invention are not limited to the example case, and the alignment data (hereinafter, referred to as alignment data A(n−1) may be created by matching respective syllable HMM's belonging to a syllable HMM set that has been trained as having the distribution number M(n−1) to respective pieces of training speech data 1. This will be described as a second exemplary embodiment. A flow of the overall processing in the second exemplary embodiment is detailed by the flowchart of FIG. 16.

FIG. 16 is the flowchart detailing the flow of the overall processing in the second exemplary embodiment. The flow of the overall processing is the same as that of FIG. 2; however, the alignment data creating processing and the description length calculating processing (Steps S24 and S25 of FIG. 16, which correspond to Steps S4 and S5 of FIG. 2) are slightly different.

That is to say, in the alignment data creating processing in the second exemplary embodiment, alignment data A(n−1) is created by matching each state in respective syllable HMM's belonging to a syllable HMM set, which has been trained as having the distribution number M(n−1), to respective pieces of training speech data 1 (Step S24). With the use of the alignment data A(n−1) thus created, the description lengths MDL (M(n−1)) and MDL (M(n)) are found for each state in respective syllable HMM sets: a syllable HMM set having the distribution number M(n−1)) and a syllable HMM set having the distribution number M(n).

A difference from the first exemplary embodiment is that the alignment data used when finding the description length MDL (M(n−1)) and the description length MDL (M(n)) is the alignment data A(n−1) (in the first exemplary embodiment, the alignment data A(n) is used).

That is to say, in the second exemplary embodiment, when the description length MDL (M(n−1)) is found, a total number of frames F(n−1) and a total likelihood P (n−1) are calculated for each state in the syllable HMM set having the distribution number M(n−1) with the use the alignment data A(n−1). Also, when the description length MDL(n) is found, a total number of frames F(n) and a total likelihood P (n) are calculated for each state in the syllable HMM set having the distribution number M(n) also with the use the alignment data A(n−1).

Other than this, the processing procedure of FIG. 16 is the same as that in FIG. 2, and the description thereof is omitted.

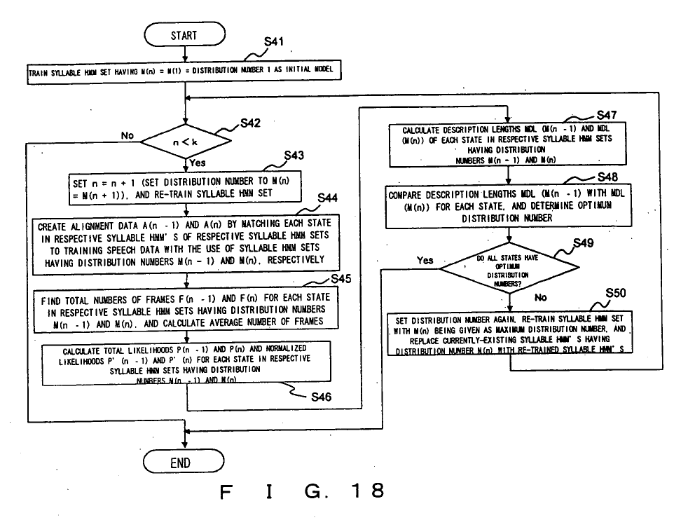

Also, FIG. 17 is a schematic showing the configuration needed to address and/or achieve the second exemplary embodiment. The components are the same as those used in the description of the first embodiment with reference to FIG. 3, and only the difference from FIG. 3 is that the alignment data obtained in the alignment data creating unit 7 is the alignment data A(n−1), which is obtained when syllable HMM's having the distribution number M(n−1) are used.

The second exemplary embodiment can attain the same advantages as those addressed and/or achieved in the first exemplary embodiment.

### Third Exemplary Embodiment

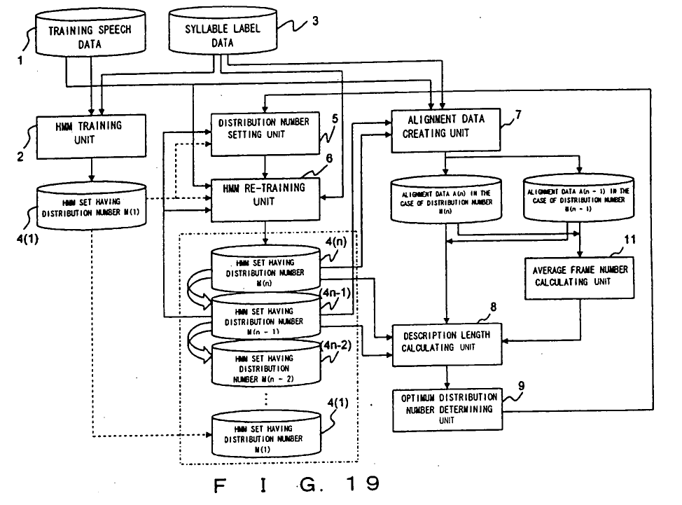

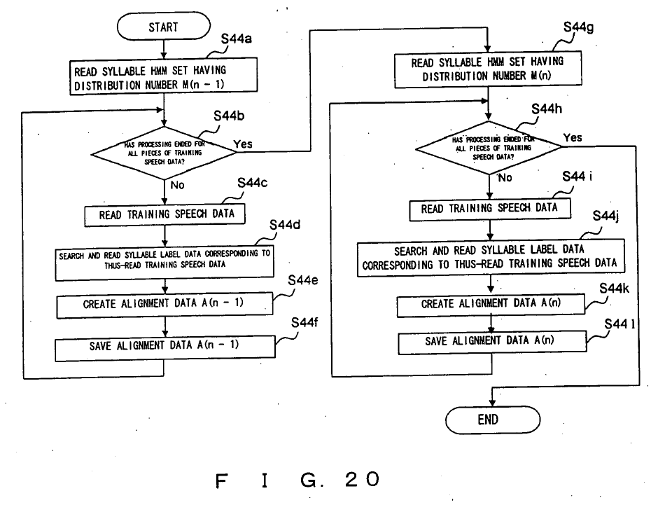

FIG. 18 is a flowchart detailing the procedure of the overall processing in a third exemplary embodiment. FIG. 19 is a view showing the configuration of the third exemplary embodiment. A flow of the overall processing in the flowchart of FIG. 18 is substantially the same as that of FIG. 2 except for the alignment data creating processing and the description length calculating processing. The alignment data creating processing and the description length calculating processing are performed in Steps S44, S45, S46 and S47 of FIG. 18, which correspond to Steps S4 and S5 of FIG. 2.

In the third exemplary embodiment, the alignment data A(n−1) is created by matching a syllable HMM set having the distribution number M(n−1) to respective pieces of training speech data 1, and the alignment data A(n) is created by matching a syllable HMM set having the distribution number M(n) to respective pieces of training speech data 1 (Step S44).

Then, total numbers of frames F(n−1) and F(n) are found for each state in respective syllable HMM's in the syllable HMM set having the distribution number M(n−1) and in the syllable HMM set having the distribution number M(n), and an average of the total frame numbers F(n−1) and F(n) is calculated, which is referred to as an average number of frames F(a) (Step S45).

Then, with the use of the average number of frames F(a), the total number of frames F(n−1), and the total likelihood P(n−1), a normalized likelihood P′(n−1) is found by normalizing the total likelihood for each state in respective syllable HMM's in the syllable HMM set having the distribution number M(n−1), and with the use of the average number of frames F(a), the total number of frames F(n), and the total likelihood P(n), a normalized likelihood P′(n) is found by normalizing the total likelihood for each state in respective syllable HMM's in the syllable HMM set having the distribution number M(n) (Step S46).

Subsequently, the description length MDL (M(n−1)) is found from Equation (2) with the use of the normalized likelihood P′(n−1) thus found and the average number of frames F(a), and the description length MDL (M(n)) is found from Equation (2) with the use of the normalized likelihood P′(n) thus found and the average number of frames F(a) (Step S47).

The description length MDL (M(n−1) and the description length MDL (M(n)) thus found are compared with each other, and when MDL (M(n−1)<MDL (M(n)) is satisfied, M(n−1) is assumed to be the optimal distribution number, and when MDL (M(n−1)<MDL (M(n)) is not satisfied, the processing (Step S48) to assume M(n) to be a tentative optimal distribution number at this point in time is performed. Incidentally, the processing in Step S48 corresponds to Steps S6, S7, S8, and S9 of FIG. 2.

When the processing in Step S48 ends, the flow proceeds to the processing in Step S49. However, the processing thereafter is the same as FIG. 2, and when the distribution numbers are not optimized for all the states, the processing in Step S50 is performed. Step S50 is identical with Step S11 of FIG. 2, and it is the processing to set the distribution number again to re-train a syllable HMM in question with M(n) being given as the maximum distribution number, and the currently-existing syllable HMM having the distribution number M(n) is replaced with the re-trained syllable HMM. The flow then returns to Step S42, and processing in Step S42 and thereafter is performed.

FIG. 19 is a schematic showing the configuration needed to address and/or achieve the third exemplary embodiment. Differences from FIG. 3 are that: two kinds of alignment data are obtained from the alignment data creating unit 7, that is, the alignment data A(n) created with the use of HMM's having the distribution number M(n) and the alignment data A(n−1) created with the use of HMM's having the distribution number M(n−1); an average frame number calculating unit 11 to calculate an average number of frames F(a) from these alignment data A(n) and A(n−1) is included. Further, in the description length calculating unit 8, with the use of the average number of frames F(a) obtained in the average frame number calculating unit 11, and the total number of frames F(n) and the total likelihood P(n) of each state in HMM's having the distribution number M(n), a normalized likelihood P′(n) is found by normalizing the total likelihood for each state in HMM's having the distribution number M(n), and with the use of the average number of frames F(a), and the total number of frames F(n−1) and the total likelihood P(n−1) of each state in HMM's having the distribution number M(n−1), a normalized likelihood P′(n−1) is found by normalizing the total likelihood for each state in HMM's having the distribution number M(n−1), after which the description length MDL (M(n−1) and the description length MDL (M(n)) are calculated.

In the case of FIG. 19, the description length calculating unit 8 finds the normalized likelihood P′(n) and the normalized likelihood P′(n−1); however, a normalized likelihood calculating device to find these normalized likelihood P′(n) and normalized likelihood P′(n−1) may be provided separately from the description length calculating unit 8.

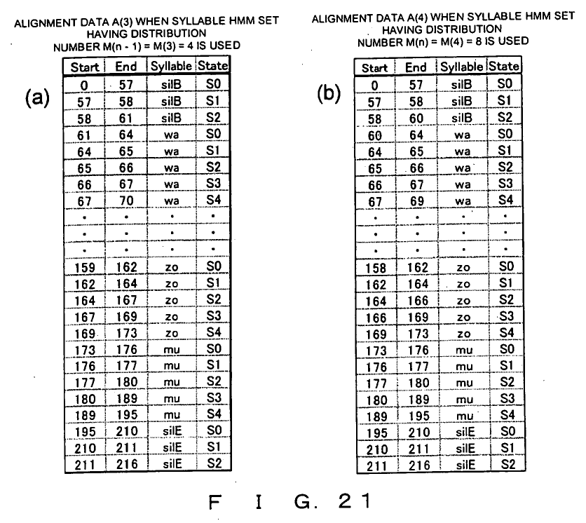

FIG. 20 is a flowchart detailing the processing in Step S44 of FIG. 18, that is, the alignment data creating processing.

Referring to FIG. 20, a syllable HMM set having the distribution number M(n−1) is read first (Step S44a), and whether processing has ended for all pieces of the training speech data is judged (Step S44b). When the processing has not ended for all pieces of the training speech data, one piece of training speech data is read from the training speech data for which the processing has not ended (Step S44c), and the syllable label data corresponding to the training speech data thus read, is searched through and read from the syllable label data 3 (Step S44d).

Subsequently, the alignment data A(n−1) is created with the use of all the syllable HMM's belonging to the syllable HMM set having the distribution number M(n−1), the training speech data 1, and the syllable label data 3 (Step S44e), and the alignment data A(n−1) is saved (Step S44f).

The processing from Step S44c through Step S44f is performed for all pieces of the training speech data 1. When the processing ends for all pieces of the training speech data 1, a syllable HMM set having the distribution number M(n) is read (Step S44g), and whether the processing has ended for all pieces of the training speech data is judged (Step S24h). When the processing has not ended for all pieces of the training speech data 1, one piece of training speech data is read from the training speech data for which the processing has not ended (Step S44i). The syllable label data corresponding to the training speech data thus read is searched through and read from the syllable label data 3 (Step S44j).

Subsequently, the alignment data A(n) is created with the use of all the syllable HMM's belonging to the syllable HMM set having the distribution number M(n), the training speech data 1, and the syllable label data 3 (Step S44k), and the alignment data A(n) is saved (Step S441).

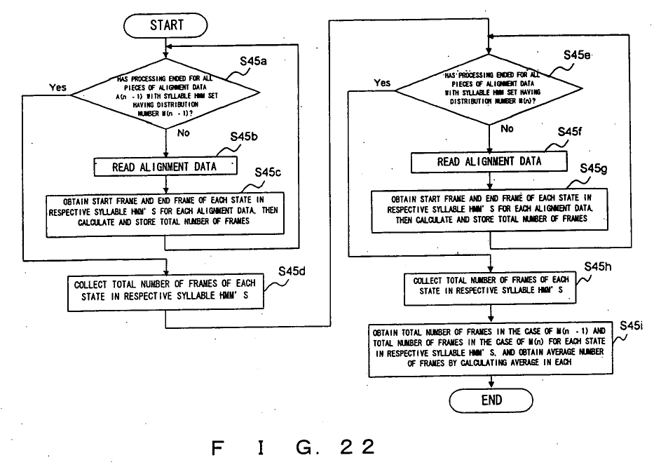

FIG. 21(a) shows an example of the alignment data A(n−1)=A(3) in a case where syllable HMM's having the distribution number M(n−1)=the distribution number M(3)=distribution number 4 are matched to the training speech data 1a, “wa ta shi wa so re o no zo mu”, used in the first exemplary embodiment. FIG. 21(b) shows an example of the alignment data A(n)=A(4) in a case where syllable HMM's having the distribution number M(n)=the distribution number M(4)=distribution number 8 are matched to the training speech data 1a, “wa ta shi wa so re o no zo mu”, used in the first exemplary embodiment.

It is understood from FIG. 21(a) and FIG. 21(b) that the obtained alignment data, the alignment data A(n−1) and the alignment data A(n), differ delicately depending on the difference of the distribution numbers even when the same training speech data is used.

FIG. 22 is a flowchart detailing the processing in Step S45 of FIG. 18, that is, the processing procedure to find the average number of frames F(a).

Referring to FIG. 22, whether the processing has ended with respect to all pieces of the alignment data A(n−1) with the use of the syllable HMM set having the distribution number M(n−1) is judged first (Step S45a).

When the processing has not ended with respect to all pieces of the alignment data A(n−1), a piece of alignment data is read from the alignment data for which the processing has not ended (Step S45b). The start frame and the end frame for each state in respective syllable HMM's for respective pieces of alignment data are thus obtained, and the total number of frames is calculated to store the calculation result (Step S45c).

The foregoing is performed for all pieces of the alignment data A(n−1), and when the processing ends for all pieces of the alignment data A(n−1), a total number of frames is collected for each state in respective syllable HMM's (Step S45d).

Then, the flow proceeds to the processing for the syllable HMM set having the distribution number M(n), and whether the processing has ended with respect to all pieces of the alignment data A(n) is judged first (Step S45e). When the processing has not ended with respect to all pieces of the alignment data A(n), a piece of alignment data is read from the alignment data for which the processing has not ended (Step S45f). The start frame and the end frame for each state in respective syllable HMM's for respective pieces of alignment data are thus obtained, and the total number of frames is calculated to store the calculation result (Step S45g).

The foregoing is performed for all pieces of the alignment data A(n), and when the processing ends for all pieces of the alignment data A(n), a total number of frames is collected for each state in respective syllable HMM's (Step S45h).

The total number of frames in the case of the distribution number M(n−1) and the total number of frames in the case of the distribution number M(n) are obtained for each state in respective syllable HMM's, and the average number of frames is obtained by calculating an average in each case (Step S45i).

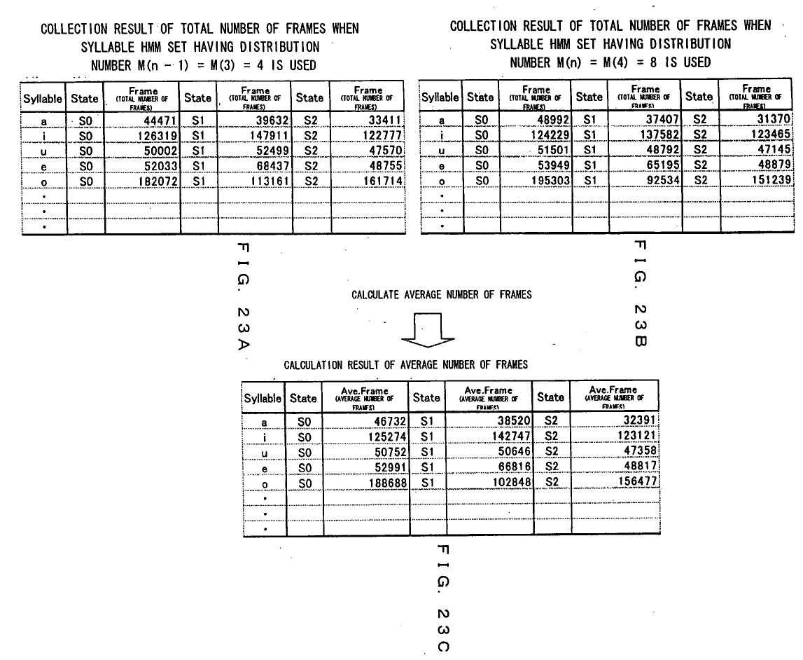

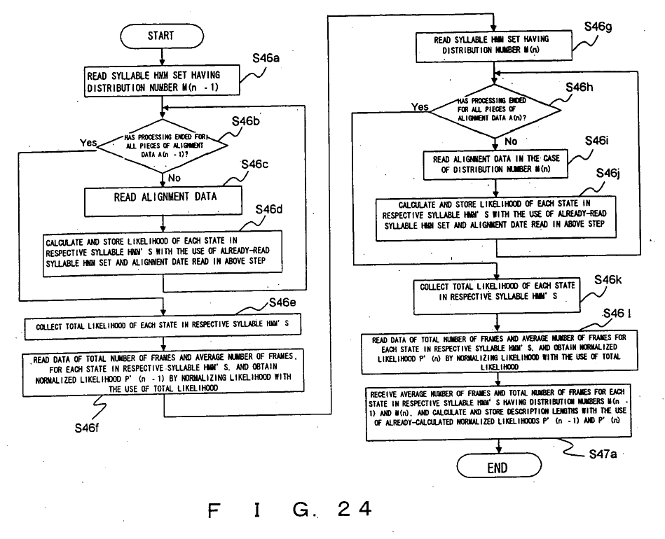

FIGS. 23A-C are views showing a concrete example of the processing to find the average number of frames of FIG. 22. FIG. 23A is an example of the collection result of the total number of frames (a total number of frames of each state for respective syllables) when a syllable HMM set having the distribution number M(n−1)=M(3)=distribution number 4 is used. FIG. 23B is an example of the collection result of the total number of frames (a total number of frames of each state for respective syllables) when a syllable HMM set having the distribution number M(n)=M(4)=distribution number 8 is used.

As has been described, because the alignment data differs when the distribution number differs, and as can be understood from FIG. 23A and FIG. 23B, the total number of frames also differs when the distribution number differs.

In this manner, with the use of collection results, as are shown in FIG. 23A and FIG. 23B, of the total number of frames in each state for respective syllables when syllable HMM's having the distribution number M(n−1)=M(3)=distribution number 4 and syllable HMM's having the distribution number M(n)=M(4)=distribution number 8 are used, an average of the total number of frames is found for each state for respective syllables, and the average numbers of frames thus obtained are set forth in FIG. 23C. In FIG. 23C, the numbers are rounded off to the one place; however, the rounding is not necessarily performed.

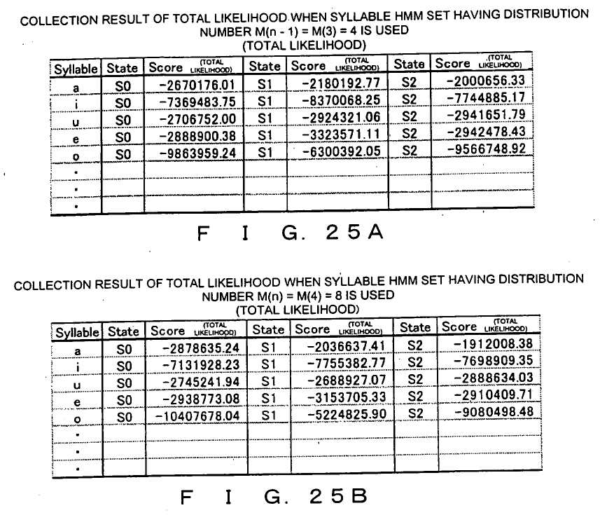

FIG. 24 is a flowchart detailing the processing in Steps S46 and S47 of FIG. 18, that is, the procedure of the description length calculating processing to find the normalized likelihoods P′(n−1) and P′(n) and to calculate the description length with the use of the normalized likelihoods P′(n−1) and P′(n).

Referring to FIG. 24, a syllable HMM set having the distribution number M(n−1) is read first (Step S46a), and whether the processing has ended with respect to all pieces of the alignment data A(n−1) is judged (Step S46b). When the processing has not ended with respect to all pieces of the alignment data A(n−1), a piece of alignment data is read from the alignment data for which the processing has not ended (Step S46c).

Then, with the use of the syllable HMM set read in Step S46a and the alignment data read in Step S46c, the likelihood is calculated for each state in respective syllable HMM's, and the calculation result is stored (Step S46d). The foregoing is performed for all pieces of the alignment data A(n−1), and when the processing with respect to all pieces of the alignment data A(n−1) ends, a total likelihood is collected for each state in respective syllable HMM's (Step S46e).

Then, data as to the total number of frames and the average number of frames for each state in respective syllable HMM's is read. The likelihood is normalized with the use of the total likelihood found in Step S46e to obtain the normalized likelihood P′(n−1) (Step S46f).

Subsequently, the flow proceeds to the processing with respect to a syllable HMM set having the distribution number M(n). The syllable HMM set having the distribution number M(n) is read first (Step S46g), and whether the processing has ended with respect to all pieces of the alignment data A(n) is judged (Step S46h). When the processing has not ended with respect to all pieces of the alignment data A(n), a piece of alignment data is read from the alignment data for which the processing has not ended (Step S46i). Then, with the use of the syllable HMM set read in Step S46g and the alignment data read in Step S46h, the likelihood is calculated for each state in respective syllable HMM's, and the calculation result is stored (Step S46j).

The foregoing is performed for all pieces of the alignment data A(n), and when the processing ends with respect to all pieces of the aligment data A(n), the total likelihood is collected for each state in respective syllable HMM's (Step S46k). The total number of frames and the average number of frames are read for each state in respective syllable HMM's, and the likelihood is normalized with the use of the total likelihood found in Step S46k to obtain the normalized likelihood P′(n) (Step S461).

When the normalized likelihood P′(n−1) and the normalized likelihood P′(n) are obtained in this manner, the description length is calculated for each state in respective syllable HMM's having the distribution number M(n−1), with the use of the normalized likelihood P′(n−1) and the average number of frames F(a), and the calculation result is stored, while the description length is calculated for each state in respective syllable HMM's having the distribution number M(n), with the use of the normalized likelihood P′(n) and the average number of frames F(a), and the calculation result is stored (Step S47a). The processing in Step S47a corresponds to Step S47 of FIG. 18.

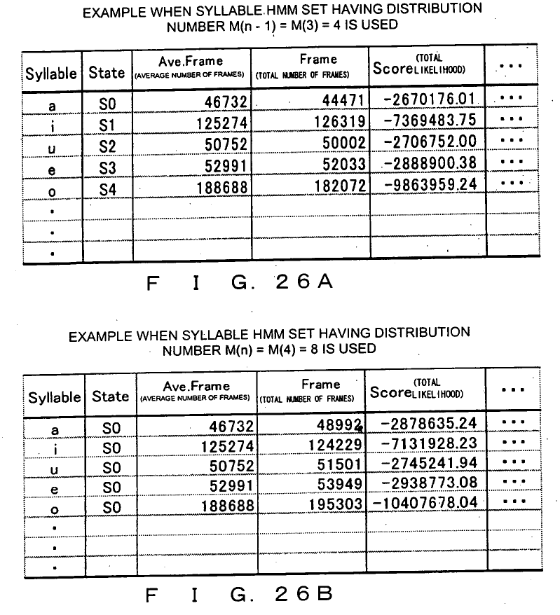

FIGS. 25A-B show the collection results of the total likelihoods in a case where a syllable HMM set having the distribution number M(n−1) is used, and in a case where a syllable HMM set having the distribution number M(n) is used. FIG. 25A shows the collection result of the total likelihood for respective syllables in each state in the syllable HMM set having the distribution number M(n−1)=M(3)=distribution number 4. FIG. 25B shows the collection result of the total likelihood for respective syllables in each state in the syllable HMM set having the distribution number M(n)=M(4)=distribution number 8.

The normalized likelihood P′(n−1) and the normalized likelihood P′(n) can be found with the use of the collection results of the total likelihoods set forth in FIG. 25A and FIG. 25B, and the total number of frames and the average number of frames set forth in FIG. 23.

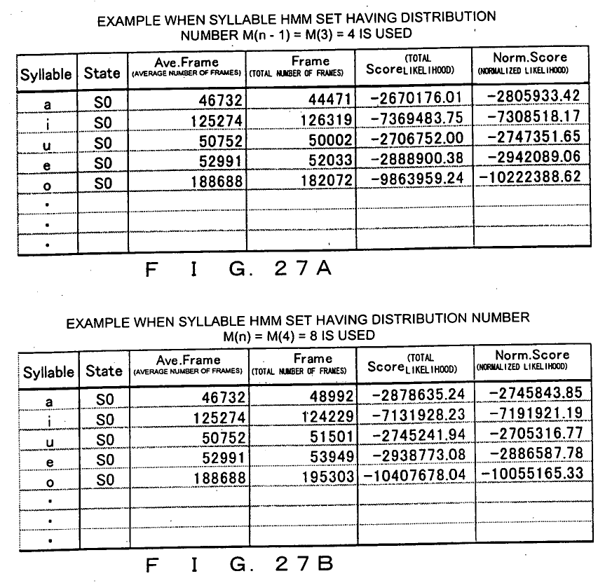

FIGS. 26A-B show compiled data as to the total number of frames, the average number of frames, and the total likelihood found thus far for each state in respective syllable HMM's in a case where a syllable HMM set having the distribution number M(n−1) is used and in a case where a syllable HMM set having the distribution number M(n) is used. FIG. 26A shows a case where a syllable HMM set having the distribution number M(n−1)=M(3)=distribution number 4 is used. FIG. 26B shows a case where a syllable HMM set having the distribution number M(n)=M(4)=distribution number 8 is used.

Normalized likelihoods are found with the use of data set forth in FIG. 26A and FIG. 26B. Herein, the normalized likelihood can be found by Equation (6): normalized likelihood=average number of frames×(total likelihood/total number of frames) . . . (6).

Hence, in the case of the distribution number M(n), let P(n) be the total likelihood at the present time, F(a) be the average number of frames, and F(n) be the total number of frames. In the case of the distribution number M(n−1), let P(n−1) be the total likelihood at the present time, F(a) be the average number of frames, and F(n−1) be the total number of frames. Then, P′(n−1) in the case of the distribution number M(n−1) and P′(n) in the case of the distribution number M(n) are found as follows from Equation (6) above.
P′(n−1)=F(a)×(P(n-1)/F(n−1)) Equation (7)
P′(n)=F(a)×(P(n)/F(n)) Equation (8)

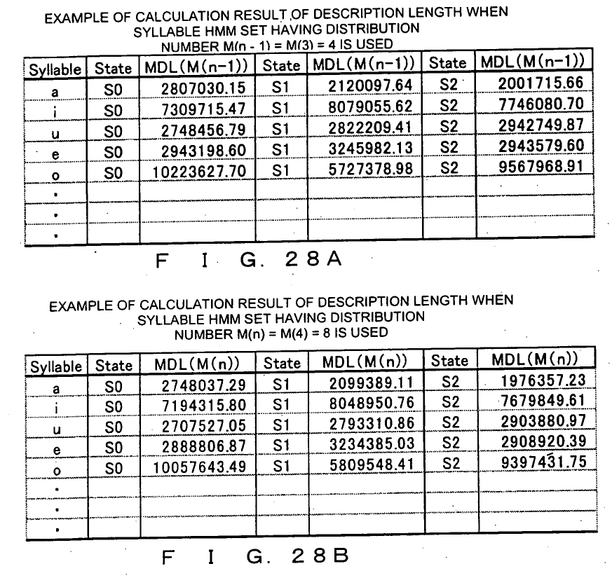

FIGS. 27A-B show one example of the normalized likelihoods (Norm. Score) found with the use of Equation (7) above and Equation (8) above.

FIG. 27A shows a case where the syllable HMM set having the distribution number M(n−1) is used, and FIG. 27B shows a case where the syllable HMM set having the distribution number M(n) is used. FIG. 27A and FIG. 27B show data obtained by adding the normalized likelihoods P′(n−1) and P′(n) obtained by Equation (7) and Equation (8), respectively, to the data of FIG. 26A and FIG. 26B, respectively.

The description lengths can be calculated with the use of the data set forth in FIG. 27. That is to say, by substituting the average number of frames F(a) for N in the second term on the right side of Equation (2), and by substituting the normalized likelihood P′(n−1) or P′(n) in the first term on the right side of Equation (2), all being set forth in FIG. 27, it is possible to find the description length of each state in respective syllable HMM's.

Herein, a value of β is a dimension number of a model, and, as with the case described above, it can be found by: distribution number×dimension number of feature vector. In this experiment example, 25 is given as the dimension number of the feature vector (cepstrum is 12 dimensions, delta cepstrum is 12 dimensions, and delta power is 1 dimension). Hence, β=25 in the case of the distribution number M(1)=1, β=50 in the case of the distribution number M(2)=2, and β=100 in the case of the distribution number M(3)=4. Herein, 1.0 is given as the weighting coefficient α.

Hence, with the use of data set forth in FIG. 27A, the description length (indicated by L(a, 0)) of the state S0 for a syllable /a/ when syllable HMM's having the distribution number M(n−1)=the distribution number M(3)=distribution number 4 is used can be found by: L(a, 0)=2805933.42+1.0×(100/2)×log(46732)=2807030.15 . . . Equation (9). Likewise, the description length (indicated by L(i, 0)) of the state S0 for a syllable /i/ can be found by: L(i, 0)=7308518.17+1.0×(100/2)×log(125274)=7309715.47. Equation (10).

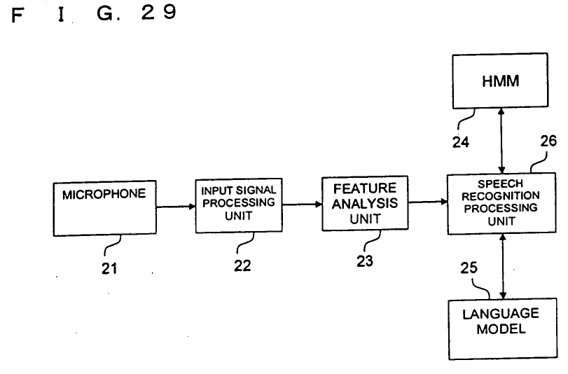

FIGS. 28A-B show the result when the description length is calculated for each state for respective syllables in a case where syllable HMM's having the distribution number M(n−1)=the distribution number M(3)=distribution number 4 is used, and when the description length is calculated for each state for respective syllables in a case where syllable HMM's having the distribution number M(n)=the distribution number M(4)=distribution number 8 is used.

Referring to FIG. 28, FIG. 28A shows an example of the description length calculation result when the syllable HMM set having the distribution number M(n−1)=the distribution number M(3)=distribution number 4 is used, and FIG. 28B shows an example of the description length calculation result when the syllable HMM set having the distribution number M(n)=the distribution number M(4)=distribution number 8 is used.

The MDL (M(n−1)) for each of the states S0, S1, and so on of FIG. 28A is the description length of each state found for respective syllables /a/, /i/, and so on, which are calculated by Equation (9) above or Equation (10) above. Likewise, the MDL (M(n)) of FIG. 28B is the description length of each state found for respective syllables /a/, /i/, and so on.

When the comparing and judging processing of the description lengths, that is, MDL (M(n−1))<MDL (M(n)), in Step S28 of FIG. 2 is performed with respect to the description lengths MDL (M(n−1) and MDL(M(n)) shown in FIG. 28A and FIG. 28B, for the states S0, the value of the description length is smaller in the case of the distribution number M(n)=M(4)=distribution number 8 for syllables /a/, /i/, /u/, and /e/, and the value of the description length is smaller in the case of the distribution number M(n−1)=M(3), that is, the distribution number 4, for only a syllable lol.

That is to say, for the states S0 in respective syllable HMM's corresponding to the syllables /a/, /i/, /u/, and /e/, the distribution number M(n)=M(4)=distribution number 8 is judged as being a tentative optimum distribution number at this point in time. Meanwhile, for the state S0 in a syllable HMM corresponding to the syllable /o/, the distribution number M(n−1)=M(3)=distribution number 4 is judged as being the optimum distribution number.

Hence, for the state S0 in the syllable HMM corresponding to the syllable /o/, distribution number M(n−1)=M(3)=distribution number 4 is assumed to be the optimum distribution number. The state S0 is thus maintained at this distribution number, and the distribution number increment processing is thus no longer performed for this state S0. Meanwhile, for the states S0 in respective syllable HMM's corresponding to the syllables /a/, /i/, /u/, and /e/, the distribution number is incremented in correspondence with the index number, which is repeated until MDL (M(n−1))<MDL (M(n)) is satisfied.

The foregoing processing is performed for all the states. Then, whether the distribution numbers for all the states are optimal numbers is judged (Step S10 of FIG. 2), that is, whether MDL (M(n−1))<MDL (M(n)) is satisfied for all the states is judged. When it is judged that the distribution numbers for all the states are optimal numbers, a syllable HMM in question is assumed to be a syllable HMM in which all the states have the optimum distribution numbers (the distributions are optimized).

In the respective syllable HMM's created through the processing as has been described, the distribution number is optimized for each state in individual syllable HMM's. It is thus possible to secure high recognition ability. Moreover, when compared with a case where the distribution number is the same for all the states, it is possible to reduce the number of parameters markedly. Hence, a volume of computation and a quantity of used memories can be reduced, the processing speed can be increased, and further, the prices and power consumption can be lowered.

Also, in exemplary embodiments of this invention, the distribution number for each state in respective syllable HMM's is incremented step by step to find the description length MDL (M(n)) in the case of the present time distribution number and the description length MDL (M(n−1)) in the case of the immediately preceding distribution number, which are compared with each other. When MDL (M(n−1))<MDL (M(n)) is satisfied, the distribution number at this point in time is maintained, and the processing to increment the distribution number step by step is no longer performed for this state. It is thus possible to set the distribution number efficiently to the optimum distribution number for each state.

Also, in the third exemplary embodiment, an average of the total number of frames F(n−1) of the syllable HMM set having the distribution number M(n−1) and the total number of frames F(n) of the syllable HMM set having the distribution number M(n) is calculated, which is referred to as the average number of frames F(a). Then, the normalized likelihood P′(n−1) is found with the use of the average number of frames F(a), the total number of frames F(n−1), and the total likelihood P(n−1), and the normalized likelihood P′(n) is found with the use of the average number of frames F(a), the total number of frames F(n), and the total likelihood P(n).

In addition, because the description length MDL (M(n−1)) is found from Equation (2) with the use of the normalized likelihood P′(n−1) and the average number of frames F(a), and the description length MDL (M(n)) is found from Equation (2) with the use of the normalized likelihood P′(n) and the average number of frames F(a), it is possible to find a description length that adequately reflects a difference of the distribution numbers. An optimum distribution number can be therefore determined more accurately.

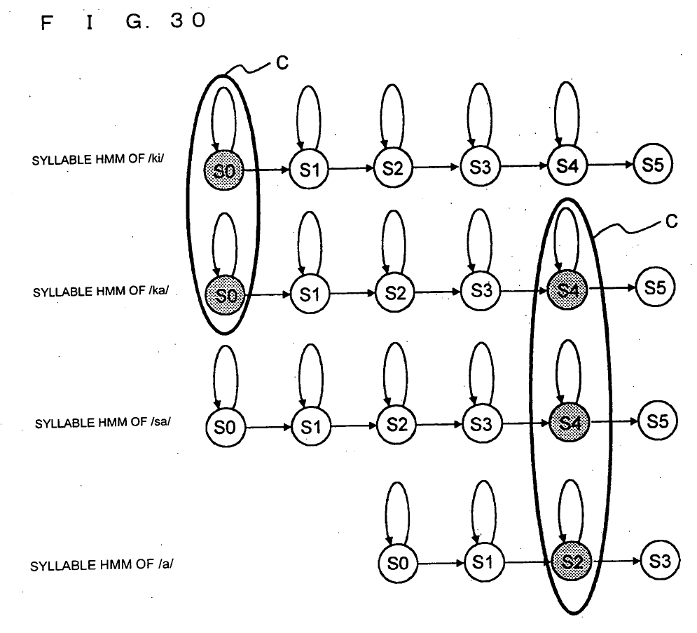

FIG. 29 is a schematic showing the configuration of a speech recognition apparatus using acoustic models (HMM's) created as has been described, which includes: a microphone 21 used to input a speech, an input signal processing unit 22 to amplify a speech inputted from the microphone 21 and to convert the speech into a digital signal; a feature analysis unit 23 to extract feature data (feature vector) from a speech signal, converted into a digital form, from the input signal processing unit; and a speech recognition processing unit 26 to recognize the speech with respect to the feature data outputted from the feature analysis unit 23, using an HMM 24 and a language model 25. Used as the HMM 24 are HMM's (the syllable HMM set in which each state has the distribution number optimized by any of the first exemplary embodiment, the second exemplary embodiment, and the third exemplary embodiment) created by the acoustic model creating method described above.

As has been described, because the respective syllable HMM's (syllable HMM's for respective 124 syllables) are syllable models having distribution numbers optimized for each sate in respective syllable HMM's, it is possible for the speech recognition apparatus to reduce the number of parameters in respective syllable HMM's markedly while maintaining high recognition ability. Hence, a volume of computation and a quantity of used memories can be reduced, and the processing speed can be increased. Moreover, because the prices and the power consumption can be lowered, the speech recognition apparatus is extremely useful as the one to be installed in a compact, inexpensive system whose hardware resource is strictly limited.

Incidentally, a recognition experiment of a sentence in 124 syllable HMM's was performed as a recognition experiment using the speech recognition apparatus that uses the syllable HMM set in which the distribution numbers are optimized by the third exemplary embodiment. Then, when the distribution numbers were the same (when the distribution numbers were not optimized), the recognition rate was 94.55%, and the recognition rate was increased to 94.80% when the distribution numbers were optimized by exemplary embodiments of the invention, from which enhancements of the recognition rate can be confirmed.

Comparison in terms of recognition accuracy reveals that when the distribution numbers were the same (when the distribution numbers were not optimized), the recognition accuracy was 93.41%, and the recognition accuracy was increased to 93.66% when the distribution numbers were optimized by exemplary embodiments of the invention (third exemplary embodiment), from which enhancement of both the recognition rate and the recognition accuracy can be confirmed.

A total distribution number in respective syllable HMM's of 124 syllables was 38366 when the distribution numbers were not optimized, which was reduced to 16070 when the distribution numbers were optimized by exemplary embodiments of the invention (third exemplary embodiment). It is thus possible to reduce a total distribution number to one-half or less of the total distribution number when the distribution numbers were not optimized.

The recognition rate and the recognition accuracy will now be described briefly. The recognition rate is also referred to as a correct answer rate, and the recognition accuracy is also referred to as correct answer accuracy. Herein, the correct answer rate (word correct) and the correct answer accuracy (word accuracy) for a word will be described. Generally, the word correct is expressed by: (total word number N—drop error number D—substitution error number S)/total word number N. Also, the word accuracy is expressed by: (total word number N—drop error number D—substitution error number S—insertion error number I)/total word number N.

The drop error occurs, for example, when the recognition result of an utterance example, “RINGO/2/KO/KUDASAI (please give me two apples)”, is “RINGO/O/KUDASAI (please give me an apple)”. Herein, the recognition result, from which “2” is dropped, has a drop error. Also, “KO” is substituted by “O”, and the recognition result also has a substitution error.

When the recognition result of the same utterance example is “MIKAN/5/KO/NISHITE/KUDASAI (please give me five oranges, instead)”, because “RINGO” is substituted by “MIKAN” and “2” is substituted by “5” in the recognition result, “MIKAN” and “2” are substitution errors. Also, because “NISHITE” is inserted, “NISHITE” is an insertion error.

The number of drop errors, the number of substation errors, and the number of insertion errors are counted in this manner, and the word correct and the word accuracy can be found by substituting these numbers into equations specified above.

### Fourth Exemplary Embodiment

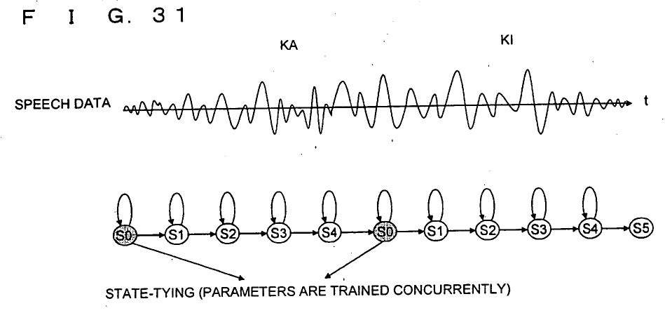

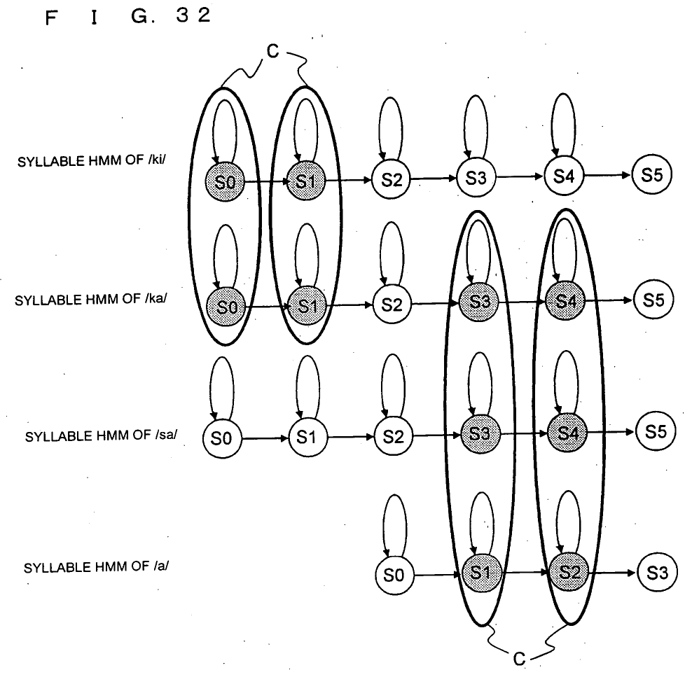

A fourth exemplary embodiment constructs, in syllable HMM's having the same consonant or the same vowel, syllable HMM's (hereinafter, referred to state-tying syllable HMM's for ease of explanation) that tie initial states or final states among plural states (states having self loops) constituting these syllable HMM's, and the techniques described in the first exemplary embodiment through the third exemplary embodiment, that is the techniques to optimize the distribution number for each state in respective syllable HMM's, are applied to the state-tying syllable HMM's. The description will be given with reference to FIG. 30.

Herein, consideration is given to syllable HMM's having the same consonant or the same vowel, for example, a syllable HMM of a syllable /ki/, a syllable HMM of a syllable /ka/, a syllable HMM of a syllable is a/, and a syllable HMM of a syllable /a/ are concerned. To be more specific, a syllable /ki/ and a syllable /ka/ both have a consonant /k/, and a syllable /ka/, a syllable /sa/, and a syllable /a/ all have a vowel /a/.

For syllable HMM's having the same consonant, states present in the preceding stage (herein, first states) in respective syllable HMM's are tied. For syllable HMM's having the same vowel, states present in the subsequent stage (herein, final states among the states having self loops) in respective syllable HMM's are tied.

FIG. 30 is a schematic showing that the first state S0 in the syllable HMM of the syllable /ki/ and the first state S0 in the syllable HMM of the syllable /ka/ are tied, and the final state S4 in the syllable HMM of the syllable /ka/, the final state S4, having a self loop, in the syllable HMM of the syllable /sa/, and the final state S2, having a self loop, in the syllable HMM of the syllable /a/ are tied. In either case, states being tied are enclosed in an elliptic frame C indicated by a thick solid line.

The states that are tied by state tying in syllable HMM's having the same consonant or the same vowel in this manner will have the same parameters, which are handled as the same parameters when syllable HMM training (maximum likelihood estimation) is performed.

For example, as is shown in FIG. 3l, when an HMM is constructed for speech data, “KAKI (persimmon)”, in which a syllable HMM of a syllable /ka/ comprising five states, S0, S1, S2, S3, and S4, each having a self loop, is connected to a syllable HMM of a syllable /ki/ comprising five states, S0, S1, S2, S3, and S4, each also having a self loop, the first state S0 in the syllable HMM of the syllable /ka/ and the first state S0 in the syllable HMM of the syllable /ki/ are tied. The state S0 in the syllable HMM of the syllable /ka/ and the state S0 in the syllable HMM of the syllable /ki/ are then handled as those having the same parameters, and thereby trained concurrently.

When states are tied as described above, the number of parameters is reduced, which can in turn reduce a quantity of used memories and a volume of computation. Hence, not only operations on a low processing-power CPU are enabled, but also power consumption can be lowered, which allows applications to a system for which lower prices are required. In addition, in a syllable having a smaller quantity of training speech data, it is expected that an advantage of reducing deterioration of recognition ability due to over-training can be addressed or achieved by reducing the number of parameters.

When states are tied as described above, for the syllable HMM of the syllable /ki/ and the syllable HMM of the syllable /ka/ taken as an example herein, a syllable HMM is constructed in which the respective first states S0 are tied. Also, for the syllable HMM of the syllable /ka/, the syllable HMM of the syllable is a/, and the syllable HMM of the syllable /a/, a syllable HMM is constructed in which the final states (in the case of FIG. 30, the state S4 in the syllable HMM of the syllable /ka/, the state S4 in the syllable HMM of the syllable /sa/, and the state S2 in the syllable HMM of the syllable /a/) are tied.

The distribution number is optimized as has been described in any of the first exemplary embodiment through the third exemplary embodiment for each state in respective syllable HMM's in which the states are tied as described above.

As has been described, in the fourth exemplary embodiment, for syllable HMM's having the same consonants or the same syllables, the state-tying syllable HMM's are constructed, in which, for example, first states or final states among plural states constituting these syllable HMM's are tied, and the techniques described in the first exemplary embodiment through the third exemplary embodiment are applied to the state-tying syllable HMM's thus constructed. The number of parameters can be then reduced further, which can in turn reduce a volume of computation and a quantity of used memories, and increase the processing speed. Further, the effect of lowering the prices and the power consumption is more significant. In addition, it is possible to create a syllable HMM in which each state has the optimized distribution number and each state has an optimum parameter.

Hence, by tying states and by creating syllable HMM's, in which each state has the optimum distribution number as has been described in the first exemplary embodiment, for respective state-tying syllable HMM's, and by applying such syllable HMM's to the speech recognition apparatus as shown in FIG. 29, it is possible to further reduce the number of parameters in respective syllable HMM's while maintaining high recognition ability.

A volume of computation and a quantity of used memories, therefore, can be reduced further, and the processing speed can be increased. Moreover, because the prices and the power consumption can be lowered, the speech recognition apparatus is extremely useful as the one to be installed in a compact, inexpensive system whose hardware resource is strictly limited due to a need for a cost reduction.

An example of state tying has been described in a case where either the initial states or the final states are tied among plural states constituting syllable HMM's in syllable HMM's having the same consonant or the same vowel; however, plural states may be tied. To be more specific, the initial states or at least two states including the initial states (for example, the initial states and the second states) in syllable HMM's may be tided for syllable HMM's having the same consonant, and for syllable HMM's having the same vowel, the final states among the states having the self loops or at least two state including the final states (for example, the final states and preceding states) in these syllable HMM's may be tied. This enables the number of parameters to be reduced further.

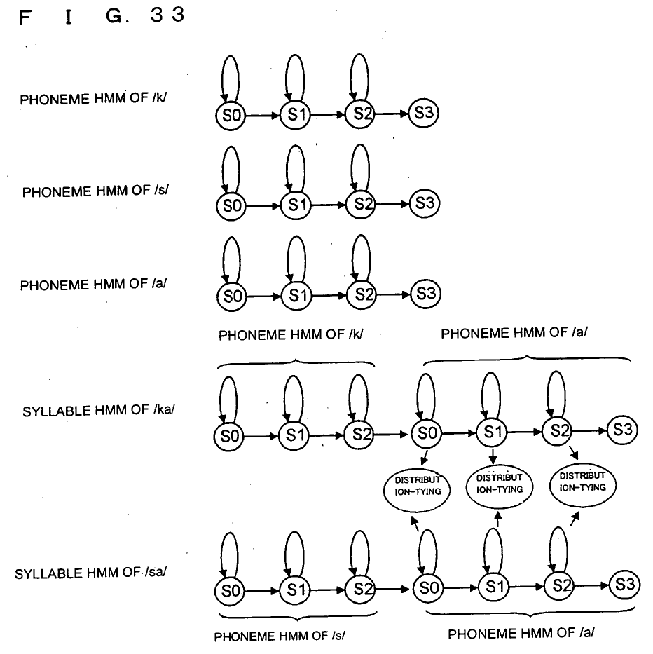

FIG. 32 is a schematic showing that, in FIG. 30 referred to earlier, the first state S0, which is the initial state, and the second state S1 in the syllable HMM of the syllable /ki/, and the first state S0, which is the initial state, and the second state S1 in the syllable HMM of the syllable /ka/ are tied, while the final state S4 and the preceding fourth state S3 in the syllable HMM of the syllable /ka/, the final state S4 and the preceding state S3 in the syllable HMM of the syllable /sa/, and the final state S2 and the preceding state S1 in the syllable HMM of the syllable /a/ are tied. In FIG. 32, too, states being tied are enclosed in an elliptic frame C indicated by a thick solid line.

The fourth exemplary embodiment has described a case where states are tied for syllable HMM's having the same consonants or the same vowels when they are connected. However, for example, in a case where a syllable HMM is constructed by connecting phoneme HMM's, the distributions of states can be tied for those having the same vowels based on the same idea.

For example, as is shown in FIG. 33, given a phoneme HMM of a phoneme /k/, a phoneme HMM of a phoneme /s/, and a phoneme HMM of a phoneme /a/, then a syllable HMM of a syllable /ka/ is constructed by connecting the phoneme HMM of the phoneme /k/ and the phoneme HMM of the phoneme /a/, and a syllable HMM of a syllable /sa/ is constructed by connecting the phoneme HMM of the phoneme /s/ and the phoneme HMM of the phoneme /a/. In this case, because vowels /a/ in the newly constructed syllable HMM of the syllable /ka/ and syllable HMM of the syllable /sa/ are the same, units corresponding to the phoneme /a/ in the syllable HMM of the syllable /ka/ and the syllable HMM of the syllable /sa/ tie the distributions in their respective states of the phoneme HMM of the phoneme /a/.

The distribution number of each state is then optimized in any of the first exemplary embodiment through the third exemplary embodiment described above for the syllable HMM of the syllable /ka/ and the syllable HMM of the syllable /sa/ that tie the distributions of the same vowel in this manner. As a result of this optimization, in these syllable HMM's that tie the distributions (in the case of FIG. 33, the syllable HMM of the syllable /ka/ and the syllable HMM of the syllable /sa/), the distribution number of the distribution-tying units (in the case of FIG. 33, the states having the self loops in the phoneme HMM of the phoneme /a/) is assumed to be the same in the syllable HMM of the syllable /ka/ and the syllable HMM of the syllable /sa/.

It should be appreciated that exemplary embodiments of the invention are not limited to the exemplary embodiments described above, and can be implemented in various exemplary modifications without deviating from the scope of exemplary embodiments of the invention. For example, in the first exemplary embodiment through the third exemplary embodiment, the description lengths, that is MDL (M(n−1)) and MDL (M(n)), are compared by judging whether MDL (M(n−1))<MDL (M(n)) is satisfied. However, a specific value (let this value be ε) may be set to judge whether MDL (M(n)−MDL (M(n−1))<ε is satisfied. By setting ε to an arbitrary value, it is possible to control the reference value for the judgment.

According to exemplary embodiments of the invention, an acoustic model creating program written with an acoustic model creating procedure to address and/or achieve exemplary embodiments of the invention as described above may be created, and recorded in a recoding medium, such as a floppy disc, an optical disc, and a hard disc. Exemplary embodiments of the invention, therefore, include a recording medium having recorded the acoustic model creating program. Alternatively, the acoustic model creating program may be obtained via a network.

1. An acoustic model creating method of optimizing Gaussian distribution numbers for respective states constituting an HMM (hidden Markov Model) for each state, and thereby creating an HMM having optimized Gaussian distribution numbers, the acoustic model creating method comprising:
incrementing a Gaussian distribution number step by step according to a specific increment rule for each state in plural HMM's, and setting each state to a specific Gaussian distribution number;
creating matching data by matching each state in respective HMM's, which has been set to the specific Gaussian distribution number in the distribution number setting, to training speech data;
finding, according to a Minimum Description Length criterion, a description length of each state in respective HMM's having a Gaussian distribution number at a present time to be outputted as a present time description length, and finding, according to the Minimum Description Length criterion, a description length of each state in respective HMM's having a Gaussian distribution number immediately preceding the present time to be outputted as an immediately preceding description length, with use of the matching data created in the matching data creating; and
comparing the present time description length with the immediately preceding description length in size, both of which are calculated in the description length calculating, and setting an optimum Gaussian distribution number for each state in respective HMM's on a basis of a comparison result.

2. The acoustic model creating method according to claim 1,
according to the Minimum Description Length criterion, when a model set {1, i, . . . , I} and data χ^{N}={χ₁, . . . , χ_{N}} (where N is a data length) are given, a description length li(χ^{N}) using a model i being expressed by a general equation (1):
$${l}_{i} ( {x}^{N} ) = - log {P}_{\hat{θ} ( i )} ( {x}^{N} ) + \frac{{β}_{i}}{2} log N + log I \qquad ( 1 )$$
where \hat{θ}(i) is a parameter of the model i, θ⁽ⁱ⁾=θ₁⁽ⁱ⁾, . . . , θ_{β}_{ᵢ}⁽ⁱ⁾ is a quantity of maximum likelihood estimation, and βᵢ is a dimension (the number of free parameters) of the model i; and
in the general equation (1) to find the description length, let the model set {1, i, . . . , I} be a set of HMM's when the distribution number for each state in the HMM is set to plural kinds from a given value to a maximum distribution number, then, given I kinds (I is an integer satisfying I≧2) as the number of the kinds of the distribution number, 1, . . . , i, . . . , I are codes to specify respective kinds from a first kind to an I'th kind, and the equation (I) is used as an equation to find a description length of an HMM having the distribution number of an i'th kind among 1, . . . , i, . . . , I.

3. The acoustic model creating method according to claim 2,
an equation, in a re-written form of the equation (1), set forth below is used as an equation (2) to find the description length:
$${l}_{i} ( {x}^{N} ) = - log {P}_{\hat{θ} ( i )} ( {x}^{N} ) + α ( \frac{{β}_{i}}{2} log N ) \qquad ( 2 )$$
where \hat{θ}(i) is a parameter of a state i and θ⁽ⁱ⁾=θ₁⁽ⁱ⁾, . . . , θ_{β}_{ᵢ}⁽ⁱ⁾ is a quantity of maximum likelihood estimation.

4. The acoustic model creating method according to claim 3,
α in the equation (2) being a weighting coefficient to obtain an optimum distribution number.

5. The acoustic model creating method according to claim 2
the data χ^{N} being a set of respective pieces of training speech data obtained by matching, for each state in time series, HMM's having an arbitrary distribution number among the given value through the maximum distribution number to many pieces of training speech data.

6. The acoustic model creating method according to claim 2
in the description length calculating, a total number of frames and a total likelihood being found for each state in respective HMM's with the use of the matching data, for respective HMM's having the present time Gaussian distribution number, and the present time description length being found by substituting the total number of frames and the total likelihood in Equation (2), while a total number of frames and a total likelihood are found for each state in respective HMM's with the use of the matching data, for respective HMM's having the immediately preceding Gaussian distribution number, and the immediately preceding description length being found by substituting the total number of frames and the total likelihood in Equation (2).

7. The acoustic model creating method according to claim 1
in the optimum distribution number determining, as a result of comparison of the present time description length with the immediately preceding description length, when the immediately preceding description length is smaller than the present time description length, the immediately preceding Gaussian distribution number being assumed to be an optimum distribution number for a state in question, and when the present time description length is smaller than the immediately preceding description length, the present time Gaussian distribution number being assumed to be a tentative optimum distribution number at this point in time for the state in question.

8. The acoustic model creating method according to claim 7,
in the distribution number setting, for the state judged as having the optimum distribution number, the Gaussian distribution number being held at the optimum distribution number, and for the state judged as having the tentative optimum distribution number, the Gaussian distribution number being incremented according to the specific increment rule.

9. The acoustic model creating method according to claim 6, further comprising, as processing prior to a description length calculation performed in the description length calculating
finding an average number of frames of a total number of frames of each state in respective HMM's having the present time Gaussian distribution number and a total number of frames of each state in respective HMM's having the immediately preceding Gaussian distribution number; and
finding a normalized likelihood by normalizing the total likelihood of each state in respective HMM's having the present time Gaussian distribution number, and finding a normalized likelihood by normalizing the total likelihood of each state in respective HMM's having the immediately preceding Gaussian distribution number.

10. The acoustic model creating method according to claim 1
the plurality of HMM's being syllable HMM's corresponding to respective syllables.

11. The acoustic model creating method according to claim 10,
for plural syllable HMM's having a same consonant or a same vowel among the syllable HMM's, of state constituting the syllable HMM's, initial states or plural states including the initial states in syllable HMM's being tied for syllable HMM's having the same consonant, and final states among states having self loops or plural states including the final states in syllable HMM's being tied for syllable HMM's having the same vowels.

12. An acoustic model creating apparatus that optimizes Gaussian distribution numbers for respective states constituting an HMM (hidden Markov Model) for each state, and thereby creates an HMM having optimized Gaussian distribution numbers, the acoustic model creating apparatus comprising:
a distribution number setting device to increment a Gaussian distribution number step by step according to a specific increment rule for each state in plural HMM's, and setting each state to a specific Gaussian distribution number;
a matching data creating device to create matching data by matching each state in respective HMM's, which has been set to the specific Gaussian distribution number by the distribution number setting device, to training speech data;
a description length calculating device to find, according to a Minimum Description Length criterion, a description length of each state in respective HMM's having a Gaussian distribution number at a present time to be outputted as a present time description length, and finding, according to the Minimum Description Length criterion, a description length of each state in respective HMM's having a Gaussian distribution number immediately preceding the present time to be outputted as an immediately preceding description length, with the use of the matching data created by the matching data creating device; and
an optimum distribution number determining device to compare the present time description length with the immediately preceding description length in size, both of which are calculated by the description length calculating device, and to set an optimum Gaussian distribution number for each state in respective HMM's on the basis of a comparison result.

13. An acoustic model creating program for use with a computer to optimize Gaussian distribution numbers for respective states constituting an HMM (hidden Markov Model) for each state, and thereby to create an HMM having optimized Gaussian distribution numbers, said acoustic model creating program comprising:
a distribution number setting procedural program for incrementing a Gaussian distribution number step by step according to a specific increment rule for each state in plural HMM's, and setting each state to a specific Gaussian distribution number;
a matching data creating procedural program for creating matching data by matching each state in respective HMM's, which has been set to the specific Gaussian distribution number in the distribution number setting procedure, to train speech data;
a description length calculating procedural program for finding, according to a Minimum Description Length criterion, a description length of each state in respective HMM's having a Gaussian distribution number at a present time to be outputted as a present time description length, and finding, according to said Minimum Description Length criterion, a description length of each state in respective HMM's having a Gaussian distribution number immediately preceding the present time to be outputted as an immediately preceding description length, with the use of the matching data created in said matching data creating procedural step; and
an optimum distribution number determining procedural program for comparing the present time description length with the immediately preceding description length in size, both of which are calculated in the description length calculating procedure, and setting an optimum Gaussian distribution number for each state in respective HMM's on the basis of a comparison result.

14. A speech recognition apparatus to recognize an input speech, using HMM's (Hidden Markov Models) as acoustic models with respect to feature data obtained through feature analysis on the input speech, the speech recognition apparatus comprising:
HMM's created by the acoustic model creating method according to claim 1 are used as the HMM's used as the acoustic models.
